(19) United States
(12) Patent Application Publication
(10) Pub. No.: US 2009/0143262 A1
(43) Pub. Date: Jun. 4, 2009

(54) Lubricant Composition

(75) Inventor: Ken Kawata, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/887,451

(22) PCT Filed: Mar. 30, 2006
(86) PCT No.: PCT/JP2006/306718

§ 371 Date: Sep. 28, 2007

(30) Foreign Application Priority Data
Mar. 30, 2005 (JP) 2005-098917

(51) Int. Cl. C10M 107/42; C08F 26/06

(52) U.S. Cl. 508/256; 526/260; 508/258

(57) ABSTRACT

A lubricant composition containing a polymer having a mesogen structure in a main chain and/or side chains thereof is disclosed.

### TECHNICAL FIELD

The present invention relates to a lubricant composition composed of a polymer comprising a mesogen structural portions as a repeating unit, and more particularly to a lubricant composition containing a polymer contributive to improvement in viscosity index, and also to exhibition of low friction property, fuel saving property and shearing stability under extreme pressure.

### RELATED ART

With enhanced spirit on preservation of the global environment in recent years, there have been growing demands on fuel saving of industrial machines and automobiles. The fuel saving needs improvement in viscosity characteristics of lubricating oils, and reduction in frictional resistance of driving units. This means improvement in the viscosity which is a principal material factor in the fluid lubrication process with the aid of a lubricating oil film, and improvement in oil material, extreme-pressure agent and additives for frictional control which are principal material factors in the process of boundary lubrication in which an interfacial lubrication film formed at the interface prevents the surfaces brought into direct contact from fusing, and lowers the frictional resistance.

The former function has been improved by employing a combination of a low-viscosity base oil for lubricating oil, and a viscosity index improver reducing film destruction due to lowered viscosity of the base oil at high temperatures. Viscosity index (VI) has been adopted as an index of the latter function, teaching that larger viscosity index means higher stability against temperature variations. The viscosity index has been known to be improved by addition of certain kind of polymer to the base oil and/or lubricating oil.

The reason why addition of a viscosity index improver can reduce temperature dependence of viscosity of the lubricating oil has been considered as follows. The viscosity index improver is less soluble into low-viscosity oil at low temperatures, so that the viscosity of the oil does not elevate, whereas the viscosity index improver becomes more soluble into the oil at high temperatures (generally 100° C.), and a viscosity increasing effect thereof consequently elevates the viscosity of the oil as a whole, in spite of decrease in the viscosity of the oil itself.

This sort of polymer is called a viscosity index improver, examples of which include polymethacrylate (PMA) (Patent Document 1), olefinic copolymer (OCP) (Patent Document 2), hydrogenated styrene/diene copolymer (SDC) (Patent Document 3), polyisobutylene (PIB) and so forth. Modes of polymerization of SDC ever developed, besides random copolymer, include block copolymer (Patent Document 4) and star-like polymer (Patent Document 5). The lubricating oils added with these polymers show respective features. PMA is excellent in an effect of increasing the viscosity index and can thereby lower the pour point, but is poor in viscosity increasing effect. Increase in the molecular weight may improve the viscosity increasing effect, but the lubricating oil in this case may drastically be degraded in the shearing stability in association to stirring of the lubricating oil. PIB shows a large effect of increasing the viscosity, but poor in increasing the viscosity index. OCP and SDC have large effects of increasing the viscosity and low viscosities at low temperatures, but is inferior to PMA in the effect of improving the viscosity index. PMA can be imparted with a property of detergent-dispersant which allows sludge to disperse into the lubricating oil, more readily than other polymers, if co-polymerized with a polar monomer (Patent Document 6). At present, multi-grade oils excellent in the effect of improving viscosity index are generally used as the lubricating oil, but viscosity index improvers having further advanced performances have been desired, in terms of coping with recent demands on improvement in fuel consumption. Compounds capable of satisfying the demands may be any combination of PMA and OCP or SDC. These compounds simply mixed are, however, less compatible with each other, causing the lubricating oil separated into two phases. In terms of preventing the separation, graft copolymers composed of two different polymers have been proposed (for example, Patent Document 7 and Patent Document 8).

On the other hand, besides the performance of improving the viscosity index, also shearing stability is required for this sort of viscosity index improver. “Shearing stability” generally means a ratio of decrease in viscosity observed after being applied with shearing force, relative to viscosity before being applied with shearing force. Therefore, being excellent in the shearing stability means that the ratio of decrease in viscosity observed after being applied with shearing force is small. Engine oil for automobiles, characterized as a lubricating oil for driving system, is applied with strong shearing force (or physical shearing force) by crank shafts and gears. By the shearing stress, molecules of polyalkyl (meth)acrylate, which is a base polymer of the viscosity index improver, may align along with the direction of shearing force (in other words, molecules may extend in a same direction), and may be cut in the polymer chain thereof to lower the molecular weight. As a consequence, the viscosity index may be lowered. This tendency becomes more distinct as the molecular weight becomes larger. It is therefore necessary to reduce the weight-average molecular weight of the viscosity index improver, in order to improve the shearing stability. Reduction in the weight-average molecular weight of the viscosity index improver, however, raises a need of increasing the amount of addition of the viscosity index improver to the lubricating oil, in order to improve the viscosity index to a sufficient level. As solutions for problems related to this matter, a method of polymerizing a vinyl-base monomer (Patent Document 9), a composition of olefinic copolymer (Patent Document 10), and a composition containing a base oil and an alkyl methacrylate (for example Patent Document 11 and 12) have been proposed, disclosing that a sufficient level of fluidity at low temperatures can be ensured at the same time.

Patent Document 13 discloses possibility of imparting an anti-shuddering performance using a specific alkyl methacrylate composition, Patent Document 14 discloses possibility of imparting an anti-oxidative performance through addition of alkyl phenols, and Patent Document 15 discloses possibility of imparting anti-coking property through addition of a polyalkylene thioether.

For the viscosity index improver aimed at improving VI of the oil, a base polymer having a short-chain alkyl (meth)acrylate co-polymerized therewith at a specific ratio (e.g., 5 to 30% by weight of short-chain alkyl (meth)acrylate) has generally been used. This is for the purpose of lowering the solubility of the base polymer in the lubricating oil at low temperatures. Further aiming at improving the viscosity index while ensuring a sufficient level of shearing stability, a trial has been made on increasing the amount of addition of the base polymer, while keeping the molecular weight thereof small, only to result in an insufficient improvement in the viscosity index. Engine oils using PMA-base viscosity index improvers have been known to suffer from heavy coking. Various proposals having been made to solve this nonconformity, however resulted in only an insufficient effect of lowering the amount of coking, despite a desirable level of sludge dispersion.

Subjects herein may now be summarized as how to ensure a performance of improving the viscosity index while ensuring the shearing stability, and in terms of material, how to prevent fragmentation of string-like polymer structure in the shear field.

On the other hand, serious concern has been arising from the environmental viewpoint in boundary lubrication film technology which directly functions to reduce friction in the boundary lubrication process for fuel saving of industrial machines and automobiles mentioned above.

As described at the beginning, the mainstream of the lubricating oil technology at present is based on combination of low-viscosity base oil and boundary lubrication film. This technique is aimed at realizing low coefficient of friction at low pressure regions by contribution of the low-viscosity base oil, whereas in the boundary lubrication process in which the oil film is broken under high pressure and large shearing force, so as to bring mutually-sliding surfaces into direct contact with each other, the technique is aimed at imparting a function of reducing friction by contribution of a layer (boundary lubrication film) formed by corroding the surfaces, assumed as being composed of steel, by phosphorus, sulfur, chlorine-containing compounds and metal complexes thereof, and also a function of imparting anti-friction property avoiding direct contact and fusion (seizing) of the boundaries.

However, all elements composing the current boundary lubrication film fall in the categories of environment load substantces or environment toxin substances, so that the lubrication technology, which supports the industry, is in need of urgent and drastic improvement on the global basis, under growing consciousness to environment as being demonstrated by successive enactment of laws such as ELV (End-of-Life Vehicles), WEEE (Waste Electrical and Electronic Equipment), and RoHS (Restriction of the use of certain Hazardous Substances in electrical and electronic equipment) in Europe.

The present inventors have reported discotic compounds having several radially-arranged side chains, based on findings that they express low friction under extreme pressures, and are preferable as an element of lubricant (Patent Documents 16 to 18), and have reported also that these discotic compounds show viscosity-pressure moduli α almost comparable to those of animal and plant oils (Non-Patent Document 1).

Absolutely different from the current technology of boundary lubrication film, by using predetermined discotic compounds, this technology allows these compounds to exhibit the process of elastic fluid lubrication under high pressures, which have not readily been expressed by the low-viscosity lubricating oils, even under extremely severe conditions which have otherwise been classified into the process of boundary lubrication in the conventional technology, and thereby successfully ensures low friction and anti-wearing property. The disk-like compounds, capable of composing these elements without environment toxin substances, are also expected as high-performance and environment-friendly technology, substituting the current technology of boundary lubrication film.

However, the discotic compounds have not successfully been obtained in a form of fluid showing low viscosity comparative to that of the current base oils, and are still on the way to satisfy all necessary performances of the lubricating oils, and to replace them without being combined with other compounds.

[Patent Document 1] Japanese Laid-Open Patent Publication No. H7-62372;
[Patent Document 2] Japanese Examined Patent Publication No. S46-34508;
[Patent Document 3] Japanese Examined Patent Publication No. S48-39203;
[Patent Document 4] Japanese Laid-Open Patent Publication No. S49-47401;
[Patent Document 5] Japanese Laid-Open Patent Publication No. S52-96695;
[Patent Document 6] Japanese Examined Patent Publication No. S51-20273;
[Patent Document 7] Japanese Examined Patent Publication No. H4-50328;
[Patent Document 8] Japanese Laid-Open Patent Publication No. H6-346078;

### [Patent Document 9] Japanese Laid-Open Patent Publication No. 2002-12883;

### [Patent Document 10] Japanese Laid-Open Patent Publication No. 2003-48931

### [Patent Document 11] Japanese Laid-Open Patent Publication No. 2004-307551

### [Patent Document 12] Japanese Laid-Open Patent Publication No. 2004-149794;

### [Patent Document 13] Japanese Laid-Open Patent Publication No. 2001-234186;

[Patent Document 14] Japanese Laid-Open Patent Publication No. H6-17077

### [Patent Document 15] Japanese Laid-Open Patent Publication No. 2002-3873;

### [Patent Document 16] Japanese Laid-Open Patent Publication No. 2002-69472;

### [Patent Document 17] Japanese Laid-Open Patent Publication No. 2003-192677;

### [Patent Document 18] Japanese Laid-Open Patent Publication No. 2004-315703; and

### [Non-Patent Document 1] Masanori HAMAGUCHI, Nobuyoshi OHNO, Kenji TATEISHI and Ken KAWATA, Proceedings of the International Tribology Conference, Tokyo, 2005-11, p. 175

### SUMMARY OF THE INVENTION

### Problems to be Resolved by the Invention

It is therefore an object of the present invention to provide a lubricant composition capable of improving the durability of lubricating oils under high-pressure/high-shearing-force field under which the viscosity index improver functions, by using a polymer having a chemical structure different from the conventional one, capable of solving the conventional problems relating to maintenance ability of improving viscosity index, effect of increasing viscosity, fluidity at low temperatures, shearing stability, anti-coking property, and anti-shuddering property, and having functions of anti-friction and low viscosity index under extreme pressures which could not have been developed by the conventional viscosity index improvers. It is another object of the present invention to provide a lubricant composition capable of keeping these performances even under use over a long period. It is still another object of the present invention to provide a novel and environment-friendly lubricant composition capable of not only improving viscosity index of lubricating oils, but also improving maintenance ability of fluidity at low temperatures, shearing stability, anti-coking property and anti-shuddering property, and expressing at the same time low friction property and anti-wearing property under high-pressure and high-shearing-force conditions, while containing no environment load substances or environment toxin substance, as results of containing a mesogen structure as a repeating unit (for example, containing it as being dissolved and/or dispersed in water or organic solvent).

### Means for Solving the Problems

The present inventors found out from our extensive investigations that use of a polymer containing a mesogen structure successfully allows a lubricant composition to express an excellent performance of improving the viscosity index, and thereby gives novel and an advanced level of development of low friction property and anti-wearing property, which could not have been achieved by any conventional viscosity index improvers, and made the present invention after some additional investigations based on these findings.

The means for solving the problems are as follows:

[1] A lubricant composition containing a polymer having a mesogen structure in a main chain and/or side chains thereof.
[2] The lubricant composition of [1], wherein said mesogen structure has a discotic structure.
[3] The lubricant composition of [1] or [2], wherein said polymer has an oligoalkyleneoxy chain, oligosiloxy chain or oligoperfluoroalkyleneoxy chain in the main chain and/or side chains thereof.
[4] The lubricant composition of [1] or [2], wherein said polymer has said mesogen structure in the main chain thereof.
[5] The lubricant composition of [4], wherein said polymer comprises a repeating unit represented by the formula (1-1) below:

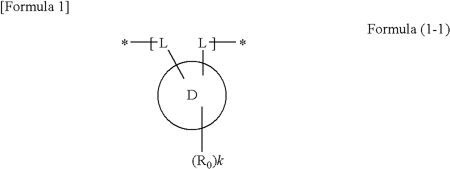

in the formula (1-1), D represents a cyclic mesogen group, each R⁰ independently represents a substituent substitutable on said cyclic mesogen group D, wherein k being not larger than a possible largest number of substitution, each L independently represents a divalent linking group, where at least one of R⁰s and Ls has an oligoalkyleneoxy chain, oligosiloxy chain or oligoperfluoroalkyleneoxy chain therein, and k is an integer of 0 or larger.

[6] The lubricant composition of [4] or [5], wherein said polymer comprises a repeating unit represented by the formula (1-2)-a or (1-2)-b below:

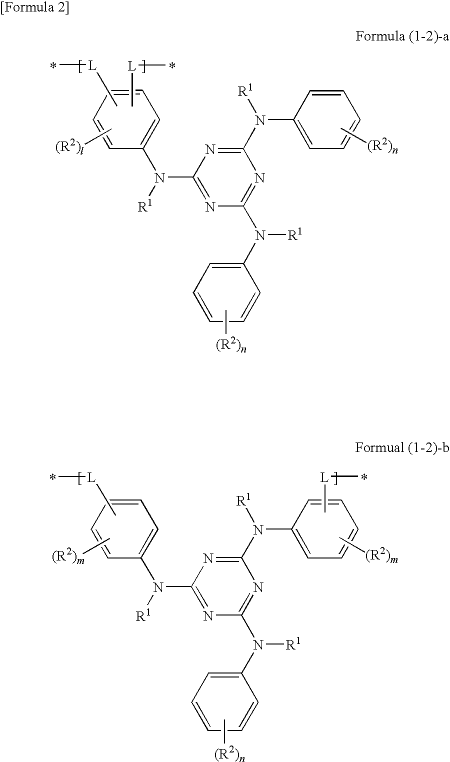

in the formulae (1-2)-a and (1-2)-b, each R¹ independently represents a hydrogen atom or alkyl group, each R² independently represents a substituent, l represents an integer of 0 to 3, m represents an integer of 0 to 4, and n represents an integer of 0 to 5, a plurality of ms and ns in the formulae may be same or different, a plurality of R²s may be same or different when l, m and n are 2 or larger, each L independently represents a divalent linking group, where at least one of R²s and Ls has an oligoalkyleneoxy chain, oligosiloxy chain or oligoperfluoroalkyleneoxy chain therein.

[7] The lubricant composition of [4] or [5], wherein said polymer is represented by the formula (1-3)-a or (1-3)-b below:

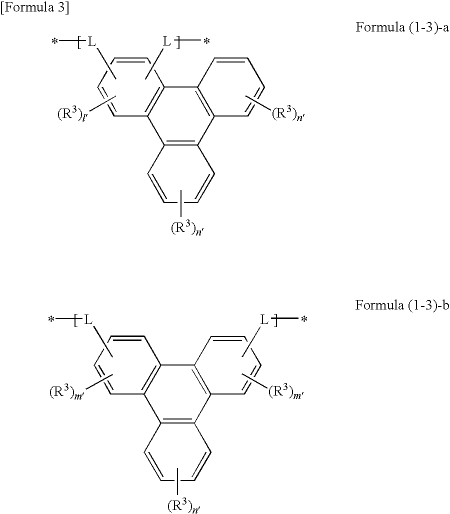

in the formulae (1-3)-a and (1-3)-b, each R³ independently represents a substituent, l′ represents an integer of 0 to 2, m′ represents an integer of 0 to 3 and n′ represents an integer of 0 to 4, a plurality of m's and n's in the formulae may be same or different, a plurality of R³s may be same or different if l′, m′ and n′ are 2 or larger, each L independently represents a divalent linking group, where at least one of R³s and Ls has an oligoalkyleneoxy chain, oligosiloxy chain or oligoperfluoroalkyleneoxy chain therein.

[8] The lubricant composition of any one of [4] to [7], wherein said polymer is polyester comprising a repeating unit derived from condensation of ester bonds.
[9] The lubricant composition of any one of [1] to [3], wherein said polymer has said mesogen structure in the side chains thereof.
[10] The lubricant composition of [9], wherein said polymer has at least a repeating unit represented by the formula (2-1) below:

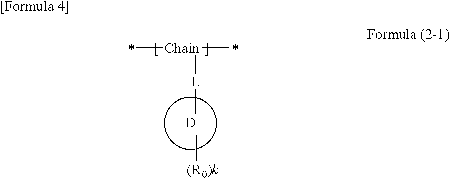

in the formula (2-1), “Chain” is a repeating unit derived from monomers composing the main chain, having at least L as a substituent, D represents a cyclic mesogen group, each R⁰ independently represents a substituent substitutable on said cyclic mesogen group D, wherein k being not larger than a possible largest number of substitution, each L independently represents a divalent linking group, where at least one of R⁰s and L has an oligoalkyleneoxy chain, oligosiloxy chain or oligoperfluoroalkyleneoxy chain therein, and k is an integer of 0 or larger.

[11] The lubricant composition of [9] or [10], wherein said polymer comprises at least a repeating unit represented by the formula (2-2) below:

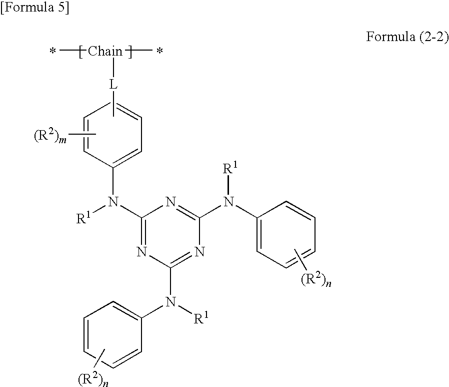

in the formula (2-2), “Chain” is a repeating unit derived from monomers composing the main chain, having at least L as a substituent, each R¹ independently represents a hydrogen atom or alkyl group, each R² independently represents a substituent, m represents an integer of 0 to 4 and n represents an integer of 0 to 5, a plurality of ns in the formula may be same or different, a plurality of R²s may be same or different if m and n are 2 or larger, each L independently represents a divalent linking group, where at least one of R²s and L has an oligoalkyleneoxy chain, oligosiloxy chain or oligoperfluoroalkyleneoxy chain.

[12] The lubricant composition of [9] or [10], wherein said polymer has at least a repeating unit represented by the formula (2-3) below:

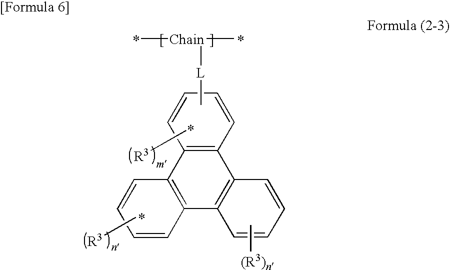

in the formula (2-3), “Chain” is a repeating unit derived from monomers composing the main chain, having at least L as a substituent, each R³ independently represents a substituent, m′ represents an integer of 0 to 3 and n′ represents an integer of 0 to 4, a plurality of n's appear in the formula may be same or different, a plurality of R³s may be same or different if m′ and n′ are 2 or larger, L represents a divalent linking group, where at least one of R³s and L has an oligoalkyleneoxy chain, oligosiloxy chain or oligoperfluoroalkyleneoxy chain therein.

[13] The lubricant composition of any one of [9] to [12], wherein the polymer is a (meth)acrylate-base polymer, polyethylene oxide-base polymer or polysiloxane-base polymer.
[14] The lubricant composition of any one of claim [1] to [13], wherein said polymer has a weight-average molecular weight of 5,000 to 200,000.
[15] The lubricant composition of any one of claim [1] to [14], wherein the mount of said polymer is 0.1 to 30% by mass relative to the total mass.
[16] The lubricant composition of any one of [1] to [15], further comprising 70 to 99.9% by mass of a lubricating oil relative to the total mass.
[17] The lubricant composition of any one of [1] to [16], said polymer is in a form of dispersed particles having a mean particle size of 10 nm to 10 μm.
[18] The lubricant composition of any one of [1] to [17], further comprising at least one species of polymer different from said polymer.
[19] The lubricant composition of any one of [1] to [18], further comprising at least one species of compound represented by the formula (4)-a, b, c, d, e, f or g below:

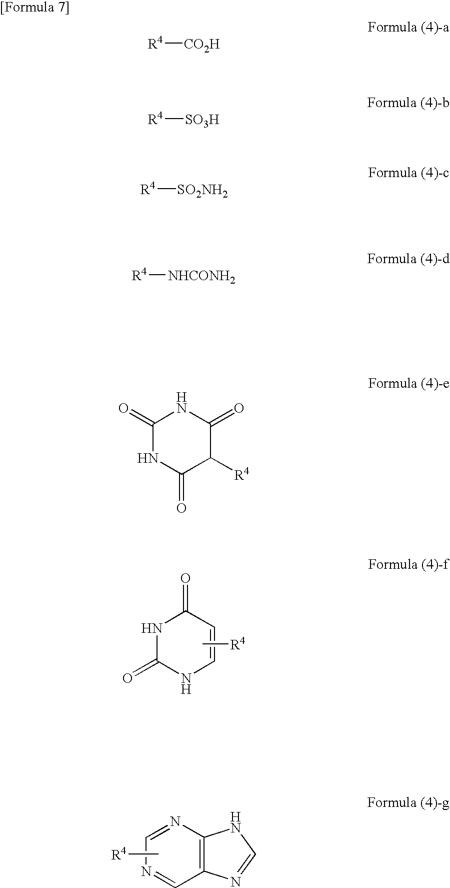

in the formulae, R⁴ represents a substituted alkyl group, phenyl group or heterocyclic group, each of which being substituted by at least one substituent containing a divalent C₈ or longer alkylene group, oligoalkyleneoxy chain, oligosiloxy chain, oligoperfluoroalkyleneoxy chain or disulfide group.

[20] A viscosity index improver comprising the lubricant composition of any one of [1] to [19].
[21] A friction modifier comprising the lubricant composition of any one of [1] to [19].
[22] The lubricant composition of any one of [1] to [14], wherein 2 or more mass parts of said polymer is dissolved in 100 mass parts of water or organic solvent.
[23] The lubricant composition of any one of [1] to [14] being a polymer dispersion composition, in which said polymer is dispersed as a particle having a mean particle size of 10 nm to 10 μm in a polymer colloidal dispersion state.
[24] The lubricant composition of [23], wherein the polymer dispersion composition is prepared via dispersion of said polymer by shearing force.
[25] The lubricant composition of [23], wherein the polymer dispersion composition is prepared according to an emulsion-dispersion method and is aqueous.
[26] The lubricant composition of [23], wherein the polymer dispersion composition is prepared according to a dispersion polymerization method and is oily.
[27] The lubricant composition of [23], wherein the polymer dispersion composition is prepared according to a dispersion polymerization method in the place of amphiphatic graft polymer or block polymer and is oily.
[28] The lubricant composition of any one of [1] to [14], wherein at least one of said polymer is dispersed as a particle having a mean particle size of 10 nm to 10 μm in a polymer colloidal dispersion state, and 2 or more mass parts of another of said polymer is dissolved in 100 mass parts of water or organic solvent.
[29] A film which is prepared by applying a lubricant composition of any one of [1] to [28] to a surface.
[30] A solid lubricant comprising a polymer having a mesogen structure in a main chain thereof.
[31] The lubricant composition of [22], further comprising at least one species of compound represented by the formula (4)-a, b, c, d, e, f or g.

### EFFECT OF THE INVENTION

According to the invention, it is possible to provide a viscosity index improver excellent in sharing stability by employing a polymer comprising at least one repeating unit having a mesogen structure therein. According to the invention, it is also possible to develop low friction property and maintain anti-wearing property under an extreme pressure by employing a polymer comprising at least one repeating unit having a mesogen structure therein and utilizing their specific properties.

An embodiment of the invention, in which the polymer is dissolved in base oil, can exhibit an excellent property capable of improving viscosity index, which is attributed to rigidity of the side chains and oil solubility of the side chain surfaces. The mesogen structure may have a relatively high-polar chemical moiety, and employing the polymer having such a mesogen structure, it is possible to provide various abilities such as dispersion ability, anti-coaking ability an anti-shuddering ability. Or in other words, according to an embodiment of the invention, it is possible to provide a novel lubricant composition capable of contributing to improvement not only in viscosity index but also in maintenance ability of fluidity at low temperatures, shearing stability, anti-coking property, and anti-shuddering property.

According to another embodiment of the invention, in which the polymer is dispersed in base oil, it is possible to provide a novel lubricant composition improved in anti-wearing ability under an extreme pressure and reduced in friction index without any loss of fluidity ability at low temperatures and low friction ability at the starting point of driving or under being applied with low load.

And the lubricant composition of the invention is excellent in environmental friendliness since it doesn't require, as a necessary element, phosphorus, sulfur, chlorine and any heavy metals.

### EMBODIMENTS OF THE INVENTION

Paragraphs below will detail the present invention. It is to be understood that any expressions of numerical ranges given in this patent specification using “to” means the ranges including the upper and lower limits indicated by the numerical values placed therebefore and thereafter.

### [Mesogen Structure]

The present invention relates to a lubricant composition containing a polymer having at least one species of polymer having a mesogen structure capable of forming a liquid crystal phase. The polymer may have the mesogen structure in the main chain or in the side chains thereof.

Important factors of exhibiting liquid crystallinity include steric factors such as linearity, flatness and rigidity, and electrostatic factors such as anisotropy in polarizability. Structures of almost all liquid crystalline compounds can schematically be expressed by a rigid core structure and flexible side chains. The mesogen structure is a coined word describing a structure having a mesophase induced (generated) therein, which corresponds to the former rigid core structure portion. Liquid crystalline compounds are classified into thermotropic liquid crystals alone capable of giving thermodynamically stable liquid crystal phase within specific ranges of temperature and pressure, and lyotropic liquid crystals capable of giving liquid crystal phase within specific ranges of temperature, pressure and concentration in solvents. However, because a compound has a mesogen structure and flexible side chains, it does not necessarily follow that it expresses liquid crystallinity. Therefore, the polymer adopted in the present invention has a mesogen structure in the repeating unit, but is not necessarily be a liquid crystalline polymer (polymer liquid crystal), or necessarily show liquid crystallinity in the temperature range in which the polymer is used.

The mesogen structure capable of forming a liquid crystal phase can be divided into a cyclic structure, a linking group, and side substituent(s). The cyclic structure includes those having a six-membered ring such as benzene ring and cyclohexane ring; those having directly combined to cyclic structures such as biphenyl and terphenyl; those having rings combined via a linking group such as tolane and hexaphenylethynylbenzene; condensed rings such as naphthalene, quinoline, anthracene, triphenylene and pyrene; and those composed of heterocycles containing nitrogen, oxygen, sulfur or the like in the ring, such as azacrown, porphyrin and phthalocyanine. Examples of the linking group include single bond, ester, amide, ureido, urethane, ether, thioether, disulfide, imino, azomethine and vinyl, and acetylene. The side substituent may affect the liquid crystallinity through its size, dipole moment and position of substitution, examples of which include halogen, nitro group, cyano group, alkoxy group, alkyl group and heterocyclic group. Further details of the above-described matter can be found in “Ekisho Binran (Handbook of Liquid Crystal)”, Chapter 3 “Bunshi Kozo to Ekisho-sei (Molecular Structure and Liquid Crystallinity)”, p. 259, edited by Editorial Committee on Handbook of Liquid Crystal, published by Maruzen Co., Ltd. (2000).

### [Mesogen-Discotic Core]

The cyclic structure is preferably discotic. The mesogen structure having a discotic cyclic structure is preferable because the anti-breakage property under shearing force, necessary for maintaining a function of improving viscosity index, can be improved by virtue of its low friction, and at the same time, it contributes to improvement in the anti-wearing property and reduction in the friction coefficient of the lubricating oil under extreme pressures.

Geometric feature of the discotic structure can typically be expressed as follows, making reference to a hydrogen substituted compound having an original form thereof. First, a molecular size may be determined as follows.

1) To create a possible planar, desirably an exact planar, molecule structure for a target molecule. For creating, standard bond-length and bond-angle values based on orbital hybridization are desirably used, and such standard values can be obtained with reference to the 15th chapter in the second volume of “Chemical Handbook, revised version 4, Foundation Section (Kagaku Binran Kaitei 4 Kisohen)” compiled by The Chemical Society of Japan, published by MARUZEN in 1993.

2) To optimize a molecular structure using the above-obtained planar structure as a default by molecular orbital method or molecular mechanics method. Examples of such methods include Gaussian92, MOPAC93, CHARMm/QUANTA and MM3, and Gaussian92 is desirably selected.

3) To move a centroid of the optimized structure to an origin position and to create a coordinate having an axis equal to a principal axis of inertia (a principal axis of a inertia tensor ellipsoid).

4) To set a sphere defined by van der Waals radius in each atom positions thereby drawing a molecular structure.

5) To calculate lengths along to three coordinate axes on van der Waals surface thereby obtaining “a”, “b” and “c”.

Using “a”, “b” and “c” obtained trough the steps 1) to 5), “a discotic structure” can be defined as a structure which satisfies a≧b≧c and a≧b≧a/2, and a preferred example of the discotic structure is a structure which satisfying a≧b≧c and a≧b≧0.7a or b/2>c. Specific examples of the compound include derivatives of core compounds typically described in “Kikan Kagaku Sosetsu (Quarterly Chemical Reviews) No. 22 “Ekisho no Kagaku (Chemistry of Liquid Crystal)”, Chapter 5, Chapter 10, Section 2, edited by the Chemical Society of Japan (1994, published by Japan Scientific Societies Press), research report by C. Destrade et al., Mol. Cryst. Liq. Cryst., Vol. 71, p. 111 (1981), research report by B. Kohne et al., Angew. Chem., Vol. 96, p. 70 (1984), research report by J. M. Lehn et al., J. Chem. Soc. Chem. Commun., p. 1794 (1985), and research report by J. Zhang, J. S. Moore et al., J. Am. Chem. Soc., Vol. 116, p. 2655 (1994). The mesogen structure is exemplified by benzene derivatives, triphenylene derivatives, tolxene derivatives, phthalocyaninederivatives, porphyrinderivatives, anthracenederivatives, azacrown derivatives, cyclohexane derivatives, β-diketone-base metal complex derivatives, hexaethynylbenzene derivatives, dibenzopyrene derivatives, coronene derivatives and phenylacetylene macrocycle derivatives. Still other examples include cyclic compounds described in “Kagaku Sosetsu (Chemical Reviews), No. 15, Atarashii Hokozoku no Kagaku (New Chemistry of Aromatic Compounds)” (1977, edited by the Chemical Society of Japan, published by University of Tokyo Press), and their heteroatom-substituted electron structural isomers. Similarly to the above-described metal complexes, the discotic core may be those capable of forming an assembly of a plurality of molecules with the aid of hydrogen bond, coordinate bond and so forth, so as to give discotic molecules. The discotic liquid crystal compound is formed by using these compounds as the center core of the molecule, having a straight-chain alkyl group or alkoxy group, substituted benzoyloxy group and so forth, as the side chains radially substituted thereon.

Preferable examples of compounds composing the center cores of the planar- and discotic-structured molecule include those represented by any one of formulae [1] to [74] below. It is to be noted that n represents an integer of 3 or larger, and * means a position bindable with the side chain. All position does not necessarily have the side chain, if * is 3 or larger. M represents a metal ion or two hydrogen atoms, so that [5] and [6] may contain a center metal or not.

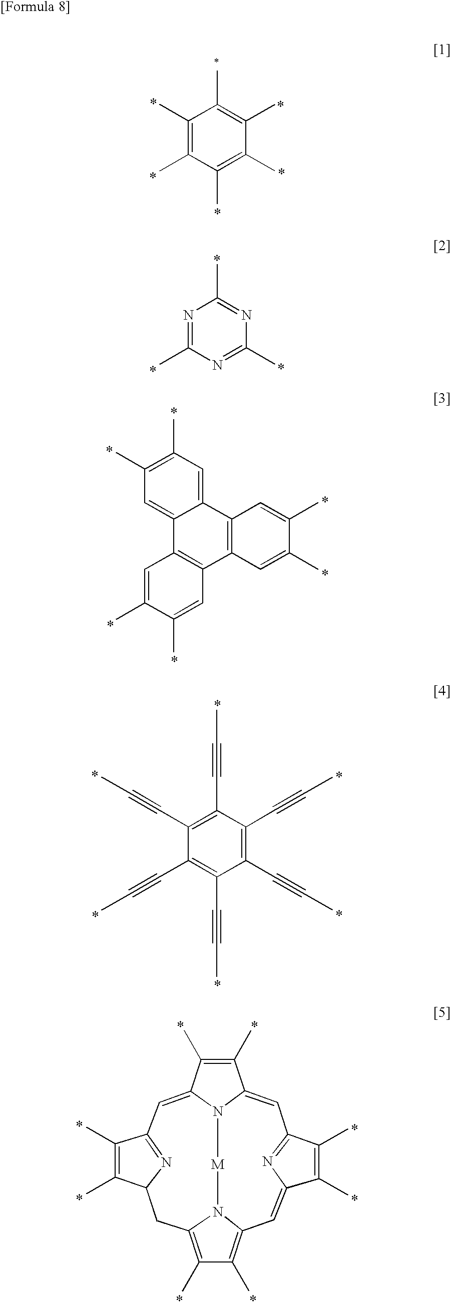

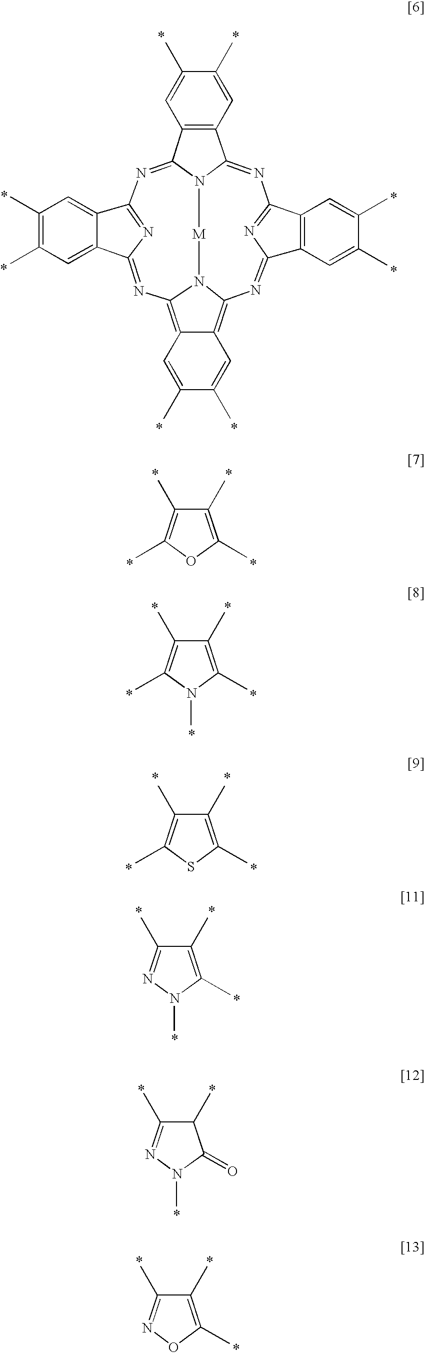

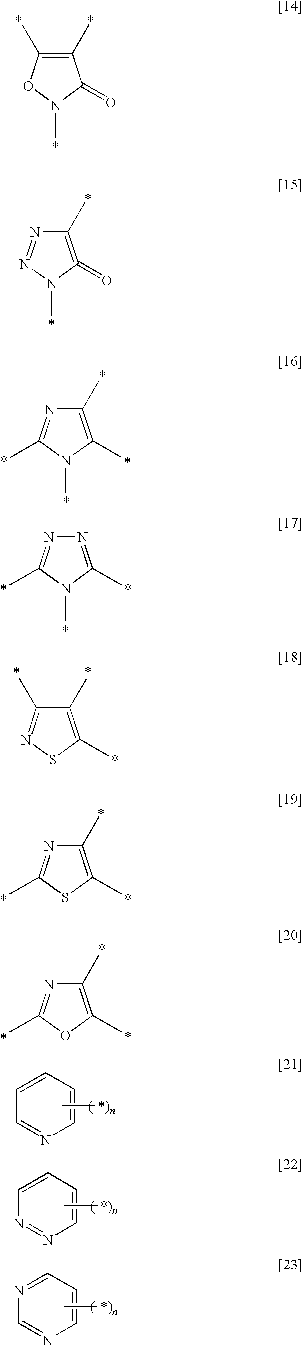

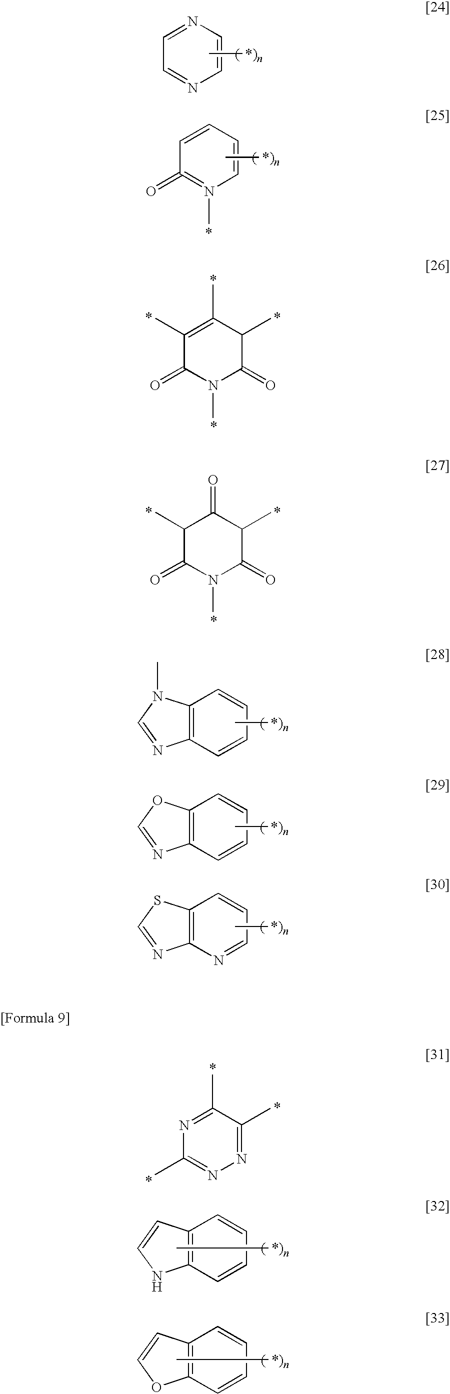

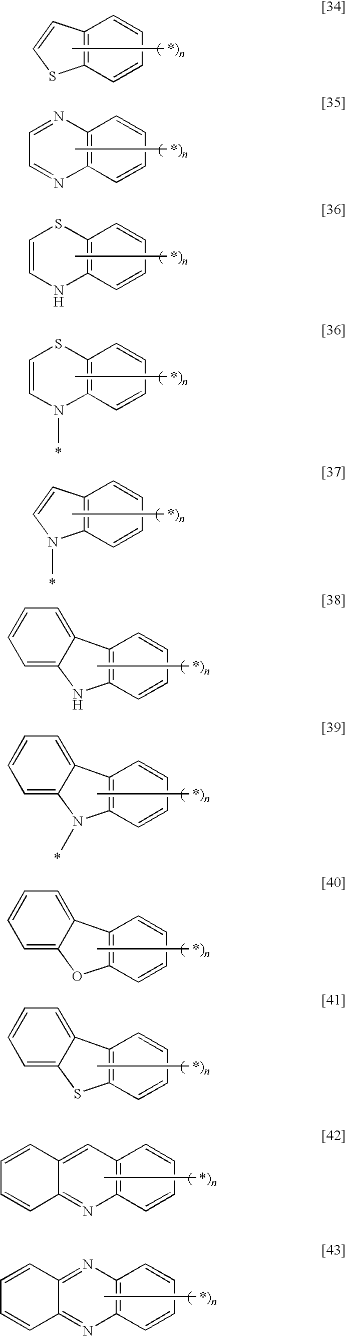

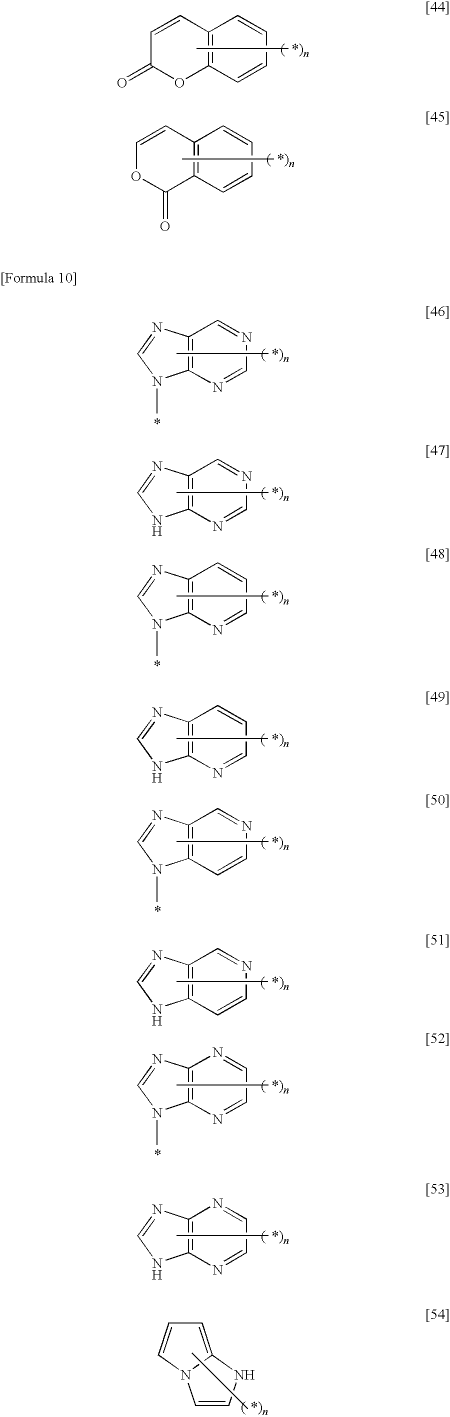

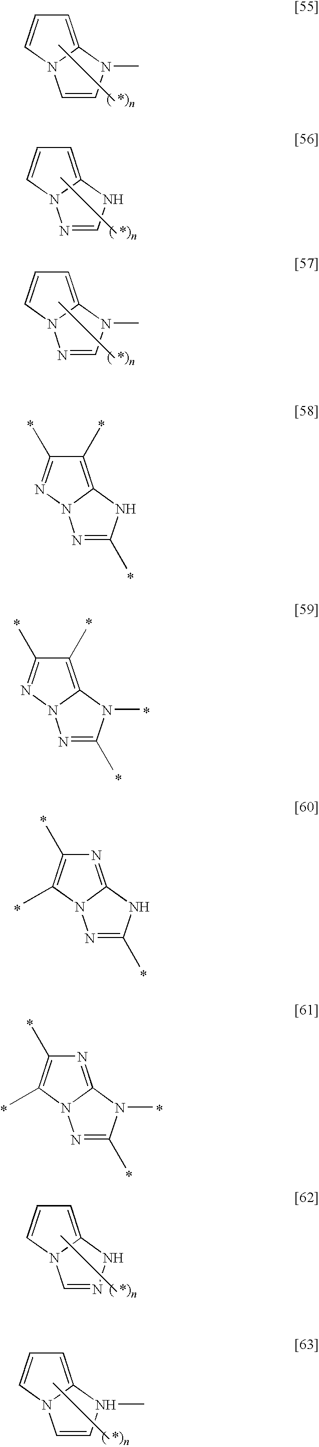

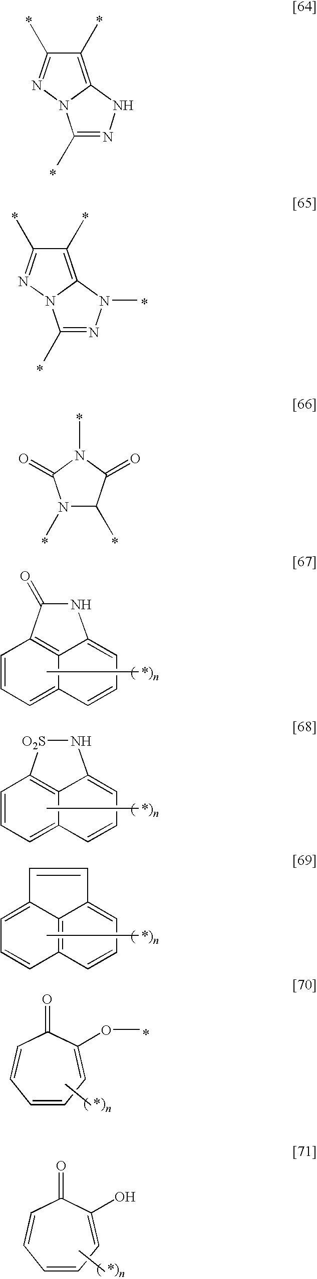

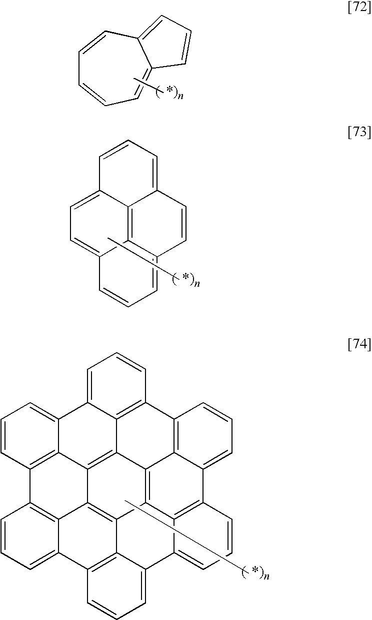

The core preferably has a π-conjugation skeleton containing polar elements. Among those listed in the above, preferable examples are [1], [2], [3], [6], [11], [12], [21], [23], [28] and [56], more preferable examples of these are [1], [2], [3], [11] and [21], and particularly preferable examples are [2], called 1,3,5-tris(arylamino)-2,4,6-triazine ring, and [3], called triphenylene ring, which correspond to those represented by formula (1-2)-a and b, formula (1-3)-a and b, formula (2-2), and formula (2-3), synthetically available at low costs.

### [Structures of Side Chains Substitutable on Mesogen Group]

Side chain substitutable on the mesogen group, corresponded to R⁰, R² and R³ in the formulae described later may generally be exemplified by an alkyl group, alkoxy group, alkoxycarbonyl group, alkylthio group and acyloxy group, wherein the side chain may contain an aryl group and heterocyclic group. The side chain may be substituted also by the substituents described in C. Hansch, A. Leo, R. W. Taft, Chem. Rev., 1991, Vol. 91, p. 165-195 (American Chemical Society), wherein the representatives include alkoxy group, alkyl group, alkoxycarbonyl group, and halogen atom. The side chain may further contain functional groups such as ether group, ester group, carbonyl group, cyano group, thioether group, sulfoxide group, sulfonyl group, and amide group.

For more detail, the side chain may be exemplified by alkanoyloxy group (e.g., hexanoyloxy, heptanoyloxy, octanoyloxy, nonanoyloxy, decanoyloxy, undecanoyloxy), alkylsulfonyl group (e.g., hexylsulfonyl, heptylsulfonyl, octylsulfonyl, nonylsulfonyl, decylsulfonyl, undecylsulfonyl), alkylthio group (e.g., hexylthio, heptylthio, dodecylthio), alkoxy group (e.g., butoxy, pentyloxy, hexyloxy, heptyloxy, octyloxy, nonyloxy, decyloxy, undecyloxy, methoxyethoxy, ethoxyethoxy, methoxydiethyleneoxy, triethyleneoxy, hexyloxydiethyleneoxy), 2-(4-alkylphenyl)ethynyl group (alkyl group is typically methyl, ethyl, propyl, butyl, pentyl, hexyl, heptyl, octyl, or nonyl), 2-(4-alkoxyphenyl)ethynyl group (alkoxy group is any one of those exemplified for the above-described alkoxy group), terminalvinyloxy (e.g., 7-vinylheptyloxy, 8-vinyloctyloxy, 9-vinylnonyloxy), 4-alkoxyphenyl group (alkoxy group is typically any of those exemplified for the above-described alkoxy group), alkoxymethyl group (alkoxy group is typically any of those exemplified for the above-described alkoxy group), alkylthiomethyl group (alkylthio group is typically any of those exemplified for the above-described alkylthio group), 2-alkylthiomethyl (alkylthio group is typically any of those exemplified for the above-described alkylthio group), 2-alkylthioethoxymethyl (alkylthio group is typically any of those exemplified for the above-described alkylthio group), 2-alkoxyethoxyethyl group (alkoxy group is typically any of those exemplified for the above-described alkoxy group), 2-alkoxycarbonyl ethyl group (alkoxy group is typically any of those exemplified for the above-described alkoxy group), cholesteryloxycarbonyl, β-sitosteryloxycarbonyl, 4-alkoxyphenoxycarbonyl group (alkoxy group is typically any of those exemplified for the above-described alkoxy group), 4-alkoxybenzoyloxy group (alkoxy group is typically any of those exemplified for the above-described alkoxy group), 4-alkylbenzoyloxy group (alkoxy group is typically any of those exemplified for the above-described 2-(4-alkylphenyl)ethynyl group), 4-alkoxybenzoyl group (alkoxy group is typically any of those exemplified for the above-described alkoxy group), perfluoroalkyl group (alkyl group is typically any of those exemplified for the above-described alkyl group), and polysiloxane group.

Of those described in the above, the phenyl group may be any other aryl groups (e.g., naphthyl group, phenanthryl group, anthracene group), or may further be substituted in addition to the above-described substituents. The phenyl group may also be any one of heteroaromatic rings (e.g., pyridyl group, pyrimidyl group, triazinyl group, thienyl group, furyl group, pyrrolyl group, pyrazolyl group, imidazolyl group, triazolyl group, thiazolyl group, imidazolyl group, oxazolyl group, thiadialyl group, oxadiazolyl group, quinolyl group, isoquinolyl group).

The number of carbon atoms in a single chain-like substituent is preferably 1 to 30, and more preferably 1 to 20.

### [Structure of Main Chain Coupling Mesogen]

In the formulae described later, the main chain coupling the mesogen, which corresponds to a linking group L may generally exemplified by an alkylene group, perfluoroalkylene group, alkenylene group, alkynylene group, phenylene group, polysiloxane group and divalent linking group based on combinations thereof. They may further be combined to each other via a divalent linking group such as oxy group, carbonyl group, ethynylene group, azo group, imino group, thioether group, sulfonyl group and disulfide group based on combinations thereof, ester group, amide group, sulfonamide group. The substituent substitutable on the main chain may be exemplified by alkyl group, cycloalkyl group, aromatic ring such as phenyl group, heterocyclic group, halogen atom, cyano group, alkylamino group, alkoxy group, hydroxyl group, amino group, thio group, sulfo group, and carboxyl group.

The linking group between the mesogen and the above-described main chain structure may be exemplified by divalent linking groups such as oxy group, carbonyl group, ethynylene group, azo group, imino group, thioether group, sulfonyl group and disulfide group based on combinations thereof, ester group, amide group, and sulfonamide group.

The main chain preferably shows liquid crystallinity in the temperature range in which it is used, because alignment of the mesogen group in the direction of sliding is expectedly follows the effect of Miesowicz low viscosity. For this purpose, and in particular for the purpose of forming a liquid crystal phase by the discotic mesogen, the smallest number of atoms composing the main chain between the mesogens is preferably 8 to 15. For expression of liquid crystal phase, a divalent group having a relatively flexible main chain structure is preferable, exemplified by alkylene group such as undecylene group, perfluoroalkylene group, triethyleneoxy group, oligoalkylenoxy group such as dipropyrene oxy group, oligoperfluoroalkylene group, and oligosiloxane group.

Although the rigidity-based repulsive force ascribable to such rigid planar structure is an important factor for development of liquid crystallinity, the present inventors found out that, at the same time, largeness of free volume allowing the flexible side chains to freely behave therein raises a novel feature not found in the conventional lubricant compositions. More specifically, the polymer having the discotic mesogen structure in the repeating unit thereof is relatively ensured with a large free volume of side chains, by virtue of several flexible side chains arranged around the rigid planar structure, and is therefore expectedly prevented from being lowered in the free volume ascribable to the repulsive force of the rigid portions beyond a certain level, even under severer pressures in which the free volume is more likely to be compressed. It is also expected that the rigid planes arranged as being stacked with each other can relax the shearing force applied to the polymer chains, in the process of re-arrangement of the planes in the direction of shearing. For this reason, the function of improving viscosity index by the lubricant composition of the present invention is expressed as relatively suppressing the rate of increase in viscosity under high pressures, so that the lubricant composition supposedly exhibits an excellent shearing stability, even under high pressures and strong shearing under which the conventional viscosity index improver would cause destruction of the polymer chain thereof due to shearing force.

The polymer having a mesogen structure in the main chain may be exemplified by polymers having repeating units represented by the formula (1-1) below:

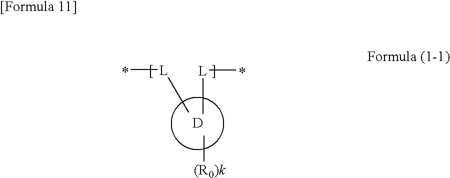

In the formula (1-1), D represents a cyclic mesogen group, each R⁰ independently represents a substituent substitutable on the cyclic mesogen group D, wherein k being not larger than a possible largest number of substitution, each L independently represents a divalent linking group, where at least one of R⁰s and Ls has a C₅ or longer (preferably C₅ to C₂₀) alkylene chain, oligoalkyleneoxy chain, oligosiloxy chain or oligoperfluoroalkyleneoxy chain therein, and preferably has an oligoalkyleneoxy chain, oligosiloxy chain or oligoperfluoroalkyleneoxy chain therein. In the formula, k is an integer of 0 or larger.

The oligoalkyleneoxy chain, oligosiloxy chain or oligoperfluoroalkyleneoxy chain preferably has 6 to 20 carbon atoms, wherein the alkylene group contained therein may be exemplified by ethylene group, propyrene group, and butyrene group, wherein the number of alkyleneoxy groups in the chain is preferably 2 to 7, and more preferably 3 to 5.

Of the polymers having the repeating units represented by the above-described formula (1-1), polymers having the repeating units represented by the formula (1-2)-a or b shown below, or the formula (1-3)-a or b shown below are preferable.

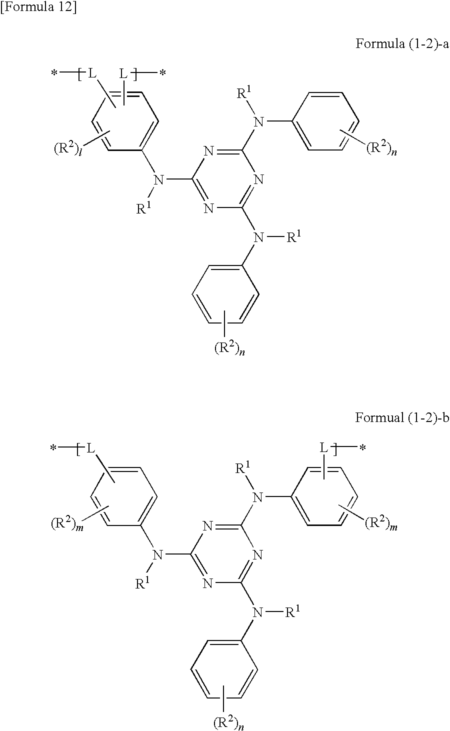

In the formulae (1-2)-a and (1-2)-b, each R¹ independently represents a hydrogen atom or alkyl group (preferably a C₃ or shorter alkyl group), each R² independently represents a substituent, l is an integer of 0 to 3, m is an integer of 0 to 4, and n is an integer of 0 to 5, a plurality of ms and ns in the formulae may be same or different, a plurality of R²s may be same or different when l, m and n are 2 or larger, each L independently represents a divalent linking group, where at least one of R²s and Ls has a C₅ or longer (preferably C₅ to C₂₀) alkylene chain, oligoalkyleneoxy chain, oligosiloxy chain or oligoperfluoroalkyleneoxy chain therein, and preferably has oligoalkyleneoxy chain, oligosiloxy chain or oligoperfluoroalkyleneoxy chain therein.

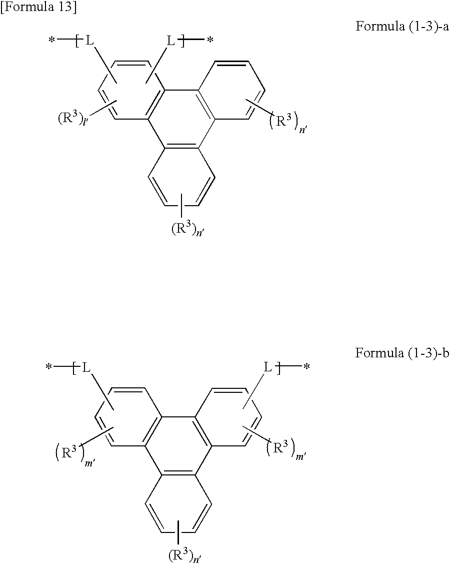

In formulae (1-3)-a and (1-3)-b, each R³ independently represents a substituent, l′ is an integer of 0 to 2, m′ is an integer of 0 to 3, and n′ is an integer of 0 to 4, a plurality of m's and n's in the formulae may be same or different, a plurality of R³s may be same or different when 1′, m′ and n′ are 2 or larger, each L independently represents a divalent linking group, where at least one of R³s and Ls has a C₅ or longer (preferably C₅ to C₂₀) alkylene chain, oligoalkyleneoxy chain, oligosiloxy chain or oligoperfluoroalkyleneoxy chain therein, and preferably has an oligoalkyleneoxy chain, oligosiloxy chain or oligoperfluoroalkyleneoxy chain therein.

The polymer having the mesogen structure as the side chains may be exemplified by the polymers having repeating units represented by the formula (2-1) below:

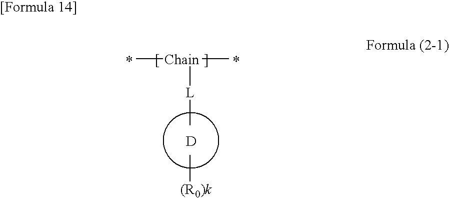

In the formula (2-1), “Chain” is a repeating unit derived from monomers composing the main chain, having at least L as a substituent, D represents a cyclic mesogen group, each R⁰ independently represents a substituent substitutable on the cyclic mesogen group D, wherein k being not larger than a possible largest number of substitution, L respectively represents a divalent linking group, where at least one of R⁰s and L has a C₅ or longer (preferably C₅ to C₂₀) alkylene chain, oligoalkyleneoxy chain, oligosiloxy chain or oligoperfluoroalkyleneoxy chain therein, and preferably has an oligoalkyleneoxy chain, oligosiloxy chain or oligoperfluoroalkyleneoxy chain therein. In the formula, k is an integer of 0 or larger.

The oligoalkyleneoxy chain, oligosiloxy chain or oligoperfluoroalkyleneoxy chain owned by the repeating unit preferably has 6 to 20 carbon atoms, wherein the alkylene group therein may be exemplified by ethylene group, propyrene group, and butyrene group, wherein the number of alkyleneoxy groups in the chain is preferably 2 to 7, and more preferably 3 to 5.

The “Chain” is a monomer residue composing the main chain, and is more specifically may be exemplified by (meth)acrylic monomer residue, methylsiloxane residue, and ethyleneoxy residue obtained by ring-opening reaction of oxirane.

Of the polymers having the repeating units represented by the above-described formula (2-1), polymers having the repeating units represented by the formula (2-2) or the formula (2-3) shown below are preferable.

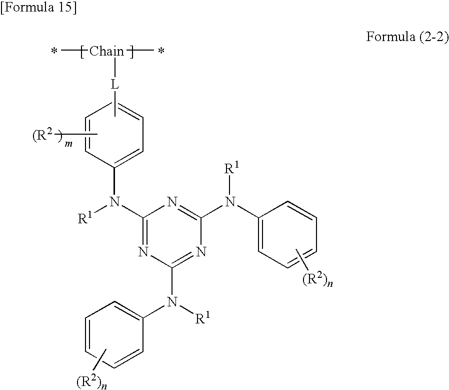

In the formula (2-2), “Chain” is a repeating unit derived from monomers composing the main chain, having at least L as a substituent, each R¹ independently represents a hydrogen atom or alkyl group (preferably C₃ or shorter alkyl group), each R² independently represents a substituent, m is an integer of 0 to 4 and n is an integer of 0 to 5, a plurality of ns in the formula may be same or different, a plurality of R²s may be same or different when m and n are 2 or larger, L respectively represents a divalent linking group, where at least one of R²s and L has a C₅ or longer (preferably C₅ to C₂₀) alkylene chain, oligoalkyleneoxy chain, oligosiloxy chain or oligoperfluoroalkyleneoxy chain therein, and preferably has an oligoalkyleneoxy chain, oligosiloxy chain or oligoperfluoroalkyleneoxy chain therein.

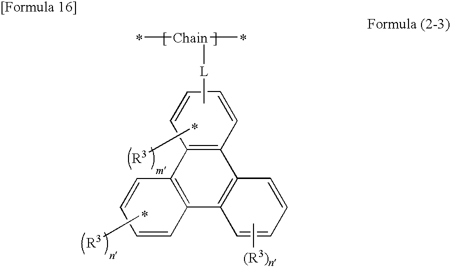

In the formula (2-3), “Chain” is a repeating unit derived from monomers composing the main chain, having at least L as a substituent, each R³ independently represents a substituent, m′ is an integer of 0 to 3 and n′ is an integer of 0 to 4, a plurality of n's appear in the formula may be same or different, a plurality of R³s may be same or different when m′ and n′ are 2 or larger, L represents a divalent linking group, where at least one of R³s and L has a C₅ or longer (preferably C₅ to C₂₀) alkylene chain, oligoalkyleneoxy chain, oligosiloxy chain or oligoperfluoroalkyleneoxy chain therein, and may preferably has an oligoalkyleneoxy chain, oligosiloxy chain or oligoperfluoroalkyleneoxy chain therein.

Of the polymers described in the above, the polymers containing the repeating units represented by the formula (2-2)′ or the repeating units represented by the formula (2-3)′ below are preferable. It is to be understood that meanings of the individual symbols in the formulae below are same as those in the above-described formulae (2) and (3). R⁵ represents a hydrogen atom or methyl group.

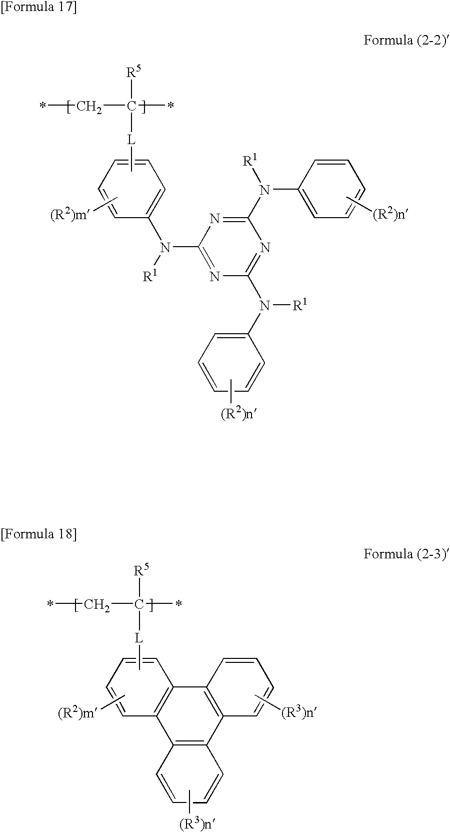

Specific examples of the polymer having the mesogen group, which can be employed in the present invention, include, however are not limited to, those shown below.

| | |
|---|---|
| | [Formula 19] |
| 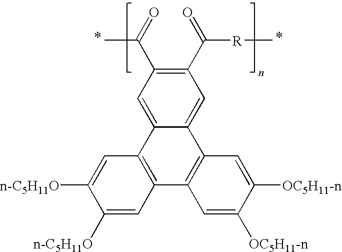 | |

| | R | n |
|---|---|---|
| DMP-1 | —OC₈H₁₆O— | 25 |
| DMP-2 | —OC₁₀H₂₀O— | 39 |
| DMP-3 | —OC₁₂H₂₄O— | 48 |
| DMP-4 | —OC₁₄H₂₈O— | 15 |
| DMP-5 | —OC₁₆H₃₂O— | 36 |

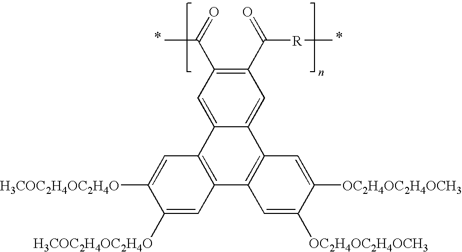

| | R | n |
|---|---|---|
| DMP-6 | —O(C₂H₄O)₂— | 32 |
| DMP-7 | —O(C₂H₄O)₃— | 25 |
| DMP-8 | —O(C₂H₄O)₄— | 21 |

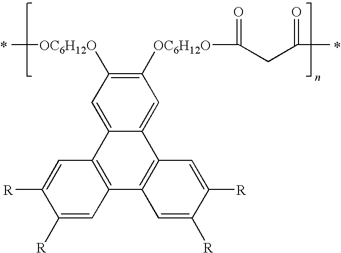

| | R |
|---|---|
| DMP-9 | —OC₅H₁₁-n |
| DMP-10 | —OC₆H₁₃-n |
| DMP-11 | —OC₆H₁₂SC₆H₁₃-n |
| DMP-12 | —O(C₂H₄O)₃C₂H₅ |
| DMP-13 | —O(C₂H₄O)₂C₆H₁₃-n |

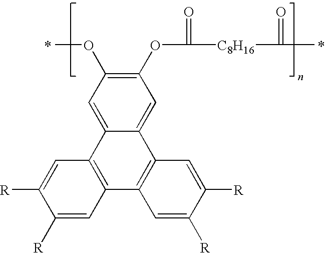

| | R |
|---|---|
| DMP-14 | —OC₁₀H₂₁-n |
| DMP-15 | —OC₆H₁₃-n |
| DMP-16 | —OC₆H₁₂SSC₆H₁₃-n |
| DMP-17 | —O(C₂H₄O)₃C₂H₅ |
| DMP-18 | —OC₆H₁₂OCOC₆H₁₃-n |

| | |
|---|---|
| | [Formula 20] |
| 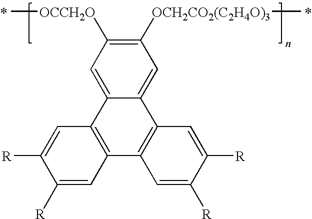 | |

| | R |
|---|---|
| DMP-19 | —O(C₂H₄O)₃C₂H₅ |
| DMP-20 | —OC₁₆H₃₃-n |

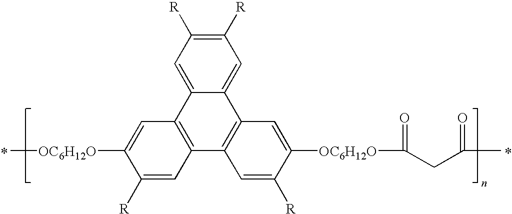

| | R |
|---|---|
| DMP-21 | —OC₈H₁₇-n |
| DMP-22 | —O(C₂H₄O)₃C₂H₅ |
| DMP-23 | —OC₆H₁₂OCOC₆H₁₃-n |
| DMP-24 | —O(C₂H₄O)₂C₂H₅ |
| DMP-25 | —OCOC₈H₁₆CO₂(C₂H₄O)₂C₆H₁₃-n |

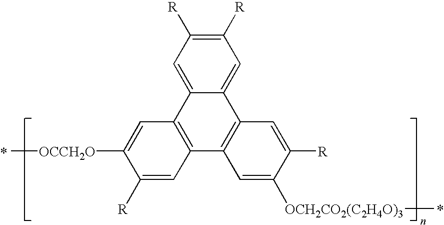

| | R |
|---|---|
| DMP-26 | —OC₈H₁₇-n |
| DMP-27 | —O(C₂H₄O)₃C₂H₅ |

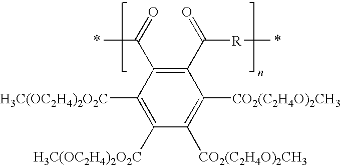

| | R |
|---|---|
| DMP-28 | —O(C₂H₄O)₂— |
| DMP-29 | —O(C₂H₄O)₃— |

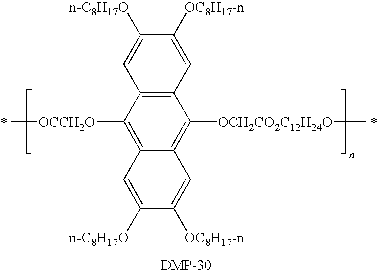

| | |
|---|---|
| | [Formula 21] |
| 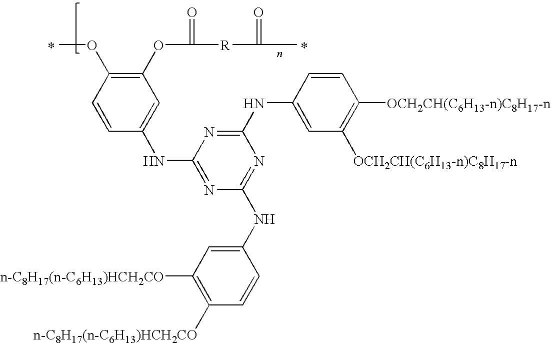 | |

| | R |
|---|---|
| DMP-31 | —C₁₀H₂₀— |
| DMP-32 | —C₁₂H₂₄— |
| DMP-33 | —C₁₄H₂₈— |
| DMP-34 | —C₁₆H₃₂— |

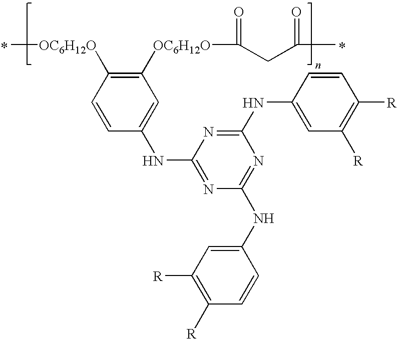

| | R |
|---|---|
| DMP-35 | —OC₁₆H₃₃-n |
| DMP-36 | —OCH₂CH(C₆H₁₃-n)C₈H₁₇-n |
| DMP-37 | —OCH₂CH(CC₁₁H₂₃-n)₂ |

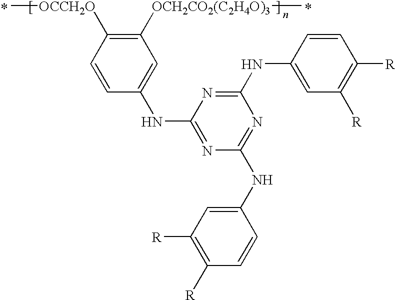

| | R |
|---|---|
| DMP-38 | —OC₂H₄C₈F₁₇-n |
| DMP-39 | —O(C₂H₄O)₃C₂H₅ |
| DMP-40 | —OC₆H₁₂OCOC₆H₁₃-n |
| DMP-41 | —O(C₂H₄O)₂CH₃ |
| DMP-42 | —OCOC₈H₁₆CO₂(C₂H₄O)₂C₆H₁₃-n |

| | |
|---|---|
| | [Formula 22] |
| 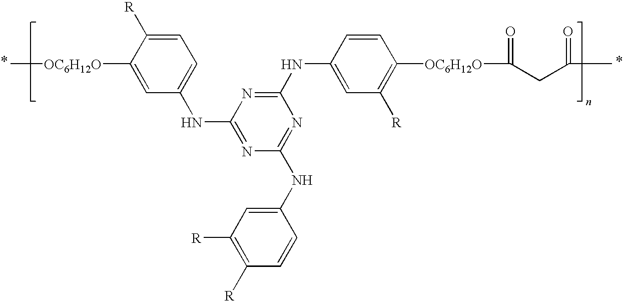 | |

| | R |
|---|---|
| DMP-43 | —O(C₂H₄O)₃C₂H₅ |
| DMP-44 | —OCH₂CH(C₆H₁₃-n)C₈H₁₇-n |

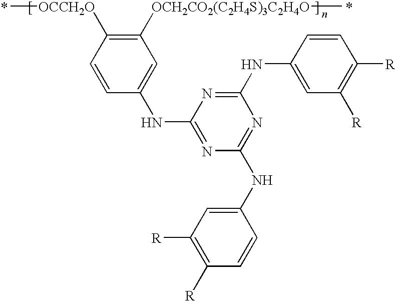

| | R |
|---|---|
| DMP-45 | —O(C₂H₄O)₃C₂H₅ |
| DMP-46 | —OCH₂CH(C₆H₁₃-n)C₈H₁₇-n |

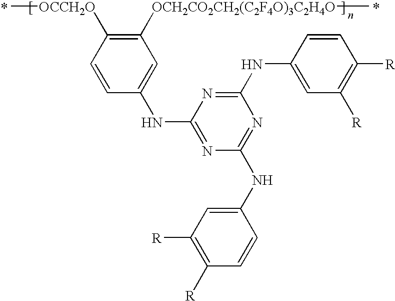

| | R |
|---|---|
| DMP-47 | —OCH₂C₆F₁₃ |
| DMP-48 | —OCH₂(C₂F₄O)₃CHF₂O(C₂F₄)₃F |

| | |
|---|---|
| | [Formula 23] |
| 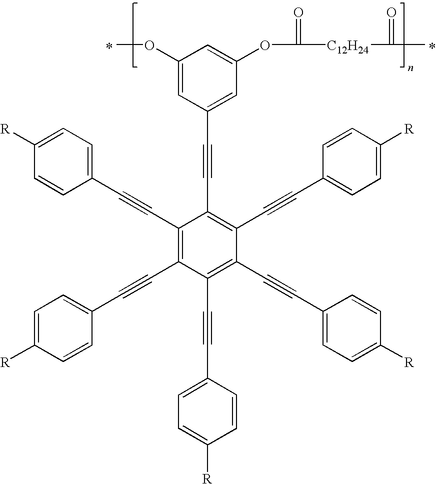 | |

| | R |
|---|---|
| DMP-49 | —OCH₂CH(C₆H₁₃-n)C₈H₁₇-n |
| DMP-50 | —O(C₂H₄O)₃C₂H₅ |
| DMP-51 | —C₁₂H₂₄ |

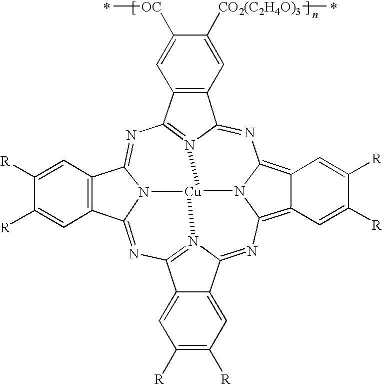

| | R |
|---|---|
| DMP-52 | —OCH₂CH(C₆H₁₃-n)C₈H₁₇-n |
| DMP-53 | —O(C₂H₄O)₃C₂H₅ |
| DMP-54 | —OC₁₂H₂₄ |

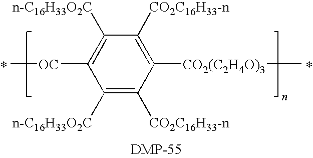

| | |
|---|---|
| | [Formula 24] |
| 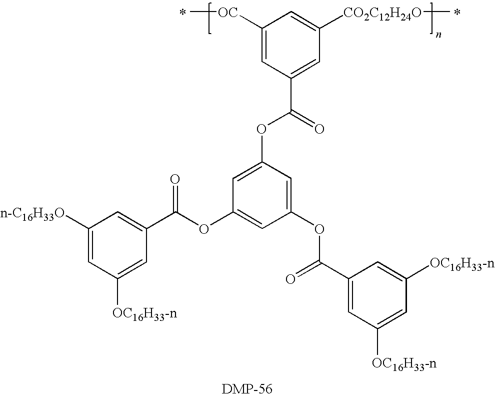 | |
| 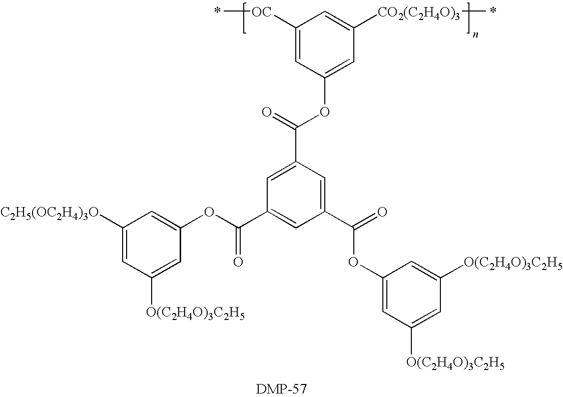 | |
| 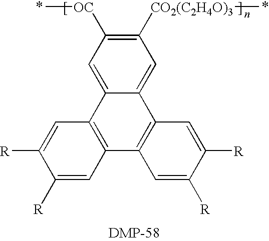 | |

R

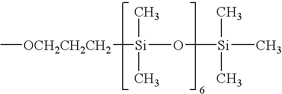

| | |
|---|---|
| | [Formula 25] |
| 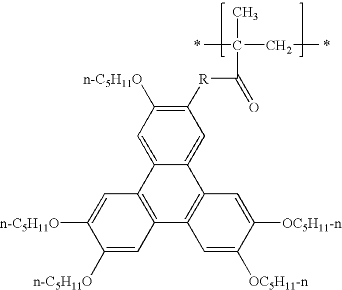 | |

| | R |
|---|---|
| DSP-1 | —OC₈H₁₆O— |
| DSP-2 | —OC₁₀H₂₀O— |
| DSP-3 | —OC₁₂H₂₄O— |
| DSP-4 | —OC₁₄H₂₈O— |
| DSP-5 | —OC₁₆H₃₂O— |

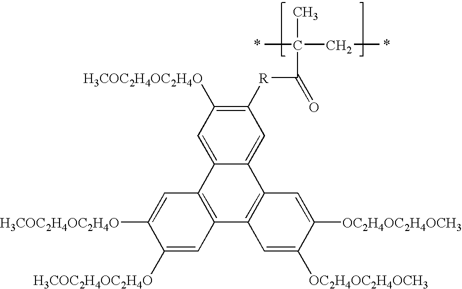

| | R |
|---|---|
| DSP-6 | —O(C₂H₄O)₂— |
| DSP-7 | —O(C₂H₄O)₃— |
| DSP-8 | —O(C₂H₄O)₄— |

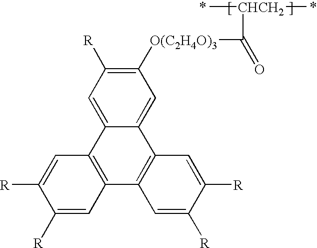

| | R |
|---|---|
| DSP-9 | —OC₅H₁₁-n |
| DSP-10 | —OC₆H₁₃-n |
| DSP-11 | —OC₆H₁₂SC₆H₁₃-n |
| DSP-12 | —O(C₂H₄O)₃C₂H₅ |
| DSP-13 | —O(C₂H₄O)₂C₆H₁₃-n |

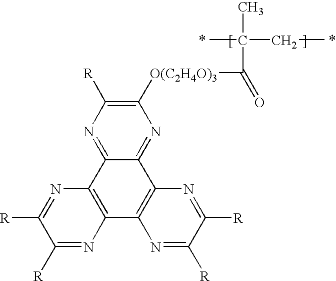

| | R |
|---|---|
| DSP-14 | —OC₁₀H₂₁-n |
| DSP-15 | —OC₆H₁₃-n |
| DSP-16 | —OC₆H₁₂SSC₆H₁₃-n |
| DSP17 | —O(C₂H₄O)₃C₂H₅ |
| DSP-18 | —OC₆H₁₂OCOC₆H₁₃-n |

| | |
|---|---|
| | [Formula 26] |
| 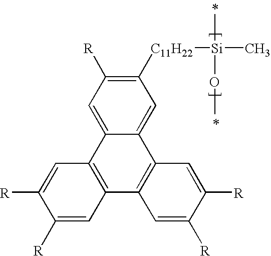 | |

| | R |
|---|---|
| DSP-19 | —OC₈H₁₇-n |
| DSP-20 | —OC₁₆H₃₃-n |

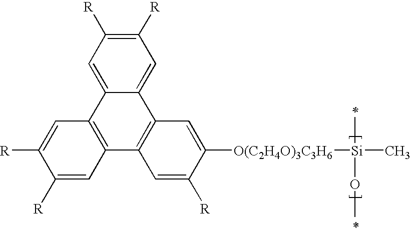

| | R |
|---|---|
| DSP-21 | —O(C₂H₄O)₄C₂H₅ |
| DSP-22 | —O(C₂H₄O)₃C₂H₅ |
| DSP-23 | —OC₆H₁₂OCOC₆H₁₃-n |
| DSP-24 | —O(C₂H₄O)₂C₂H₅ |
| DSP-25 | —OCOC₈H₁₆CO₂(C₂H₄O)₂C₆H₁₃-n |

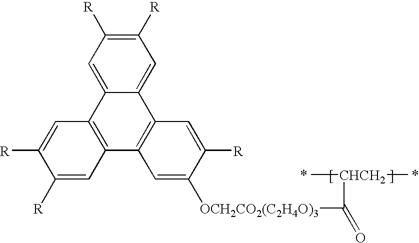

| | R |
|---|---|
| DSP-26 | —OC₈H₁₇-n |
| DSP-27 | —O(C₂H₄O)₃C₂H₅ |

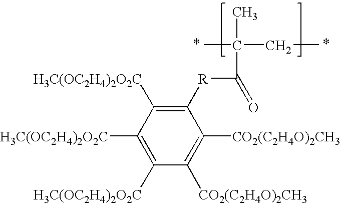

| | R |
|---|---|
| DSP-28 | —O(C₂H₄O)₂— |
| DSP-29 | —O(C₂H₄O)₃— |
| DSP-30 | 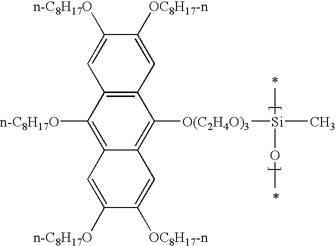 |

| | |
|---|---|
| | [Formula 27] |
| 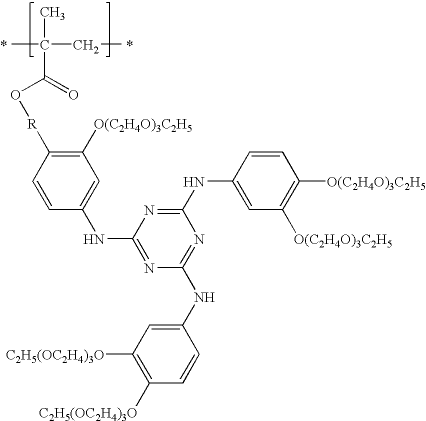 | |

| | R |
|---|---|
| DSP-31 | —O(C₂H₄O)₃— |
| DSP-32 | —O(C₂H₄O)₄— |
| DSP-33 | —O(C₂H₄O)₅— |
| DSP-34 | —OC₈H₁₆CO₂— |

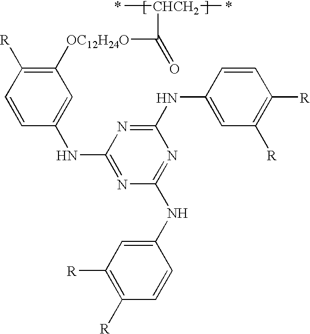

| | R |
|---|---|
| DSP-35 | —OC₁₆H₃₃-n |
| DSP-36 | —OCH₂CH(C₆H₁₃-n)C₈H₁₇-n |
| DSP-37 | —OCH₂CH(CC₁₁H₂₃-n)₂ |

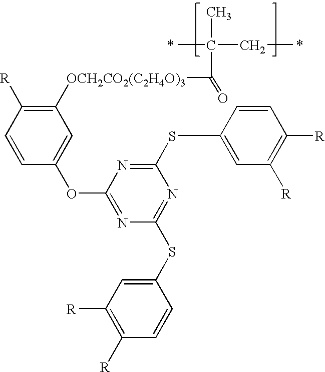

| | R |
|---|---|
| DSP-38 | —OC₂H₄C₈F₁₇-n |
| DSP-39 | —O(C₂H₄O)₃C₂H₅ |
| DSP-40 | —OC₆H₁₂OCOC₆H₁₃-n |
| DSP-41 | —O(C₂H₄O)₂CH₃ |
| DSP-42 | —OCOC₈H₁₆CO₂(C₂H₄O)₂C₆H₁₃-n |

| | |
|---|---|
| | [Formula 28] |
| 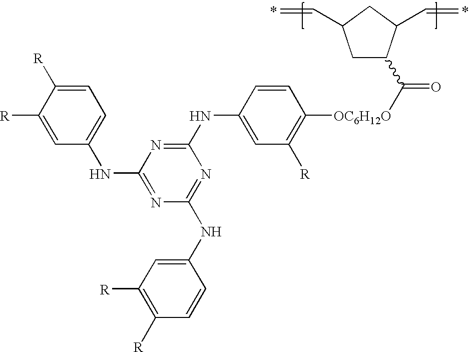 | |

| | R |
|---|---|
| DSP-43 | —O(C₂H₄O)₃C₂H₅ |
| DSP-44 | —OCH₂CH(C₆H₁₃-n)C₈H₁₇-n |

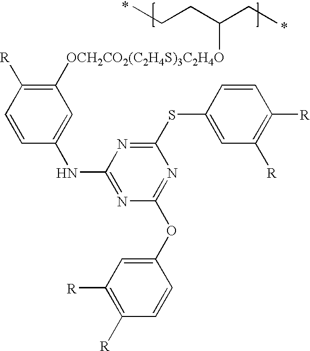

| | R |
|---|---|
| DSP-45 | —O(C₂H₄O)₃C₂H₅ |
| DSP-46 | —OCH₂CH(C₆H₁₃-n)C₈H₁₇-n |

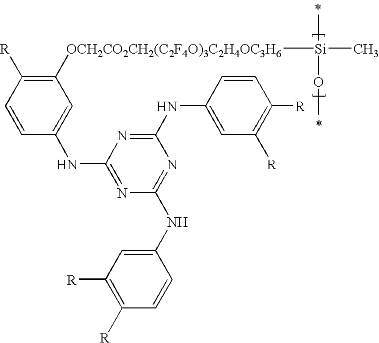

| | R |
|---|---|
| DSP-47 | —OCH₂C₆F₁₃ |
| DSP-48 | —OCH₂(C₂F₄O)₃CHF₂O(C₂F₄)₃F |

| | |
|---|---|
| | [Formula 29] |
| 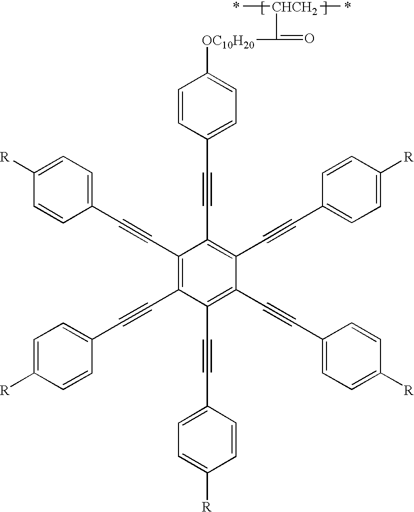 | |

| | R |
|---|---|
| DSP-49 | —OCH₂CH(C₆H₁₃-n)C₈H₁₇-n |
| DSP-50 | —O(C₂H₄O)₃C₂H₅ |
| DSP-51 | —C₁₂H₂₄ |

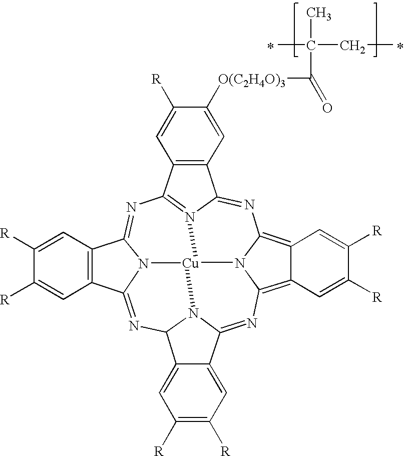

| | R |
|---|---|
| DSP-52 | —OCH₂CH(C₆H₁₃-n)C₈H₁₇-n |
| DSP-53 | —O(C₂H₄O)₃C₂H₅ |
| DSP-54 | —OC₁₂H₂₄ |

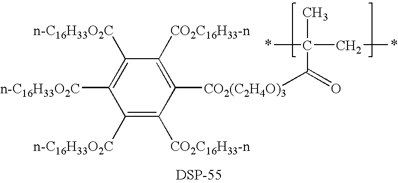

| | |
|---|---|
| | [Formula 30] |
| 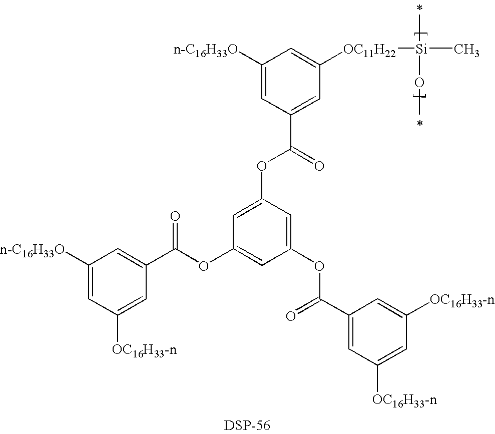 | |
| 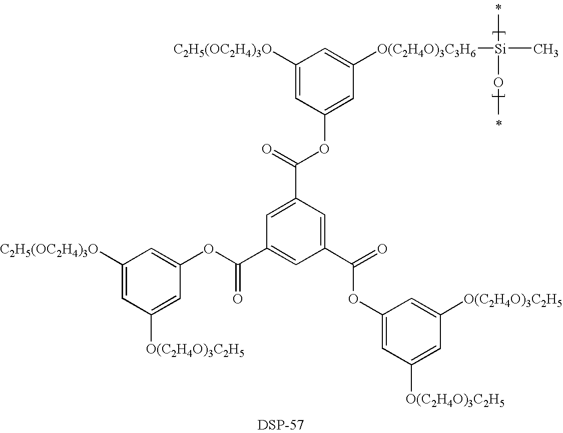 | |
| 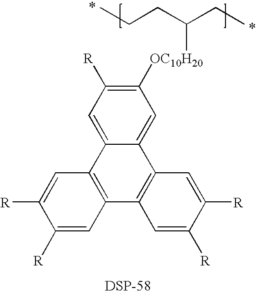 | |

R

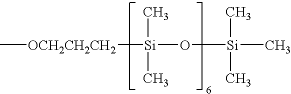

| | |
|---|---|
| | [Formula 31] |
| 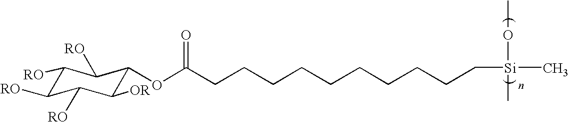 | |

| | R |
|---|---|
| DSP-59 | —COC₉H₁₉-n |
| DSP-60 | —COC₅H₁₁-n |

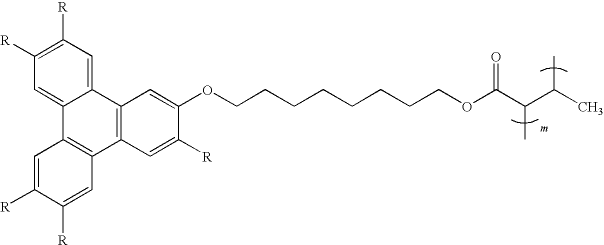

| | R |
|---|---|
| DSP-61 | —OC₈H₁₇ |
| DSP-62 | —OC₁₆H₃₃ |

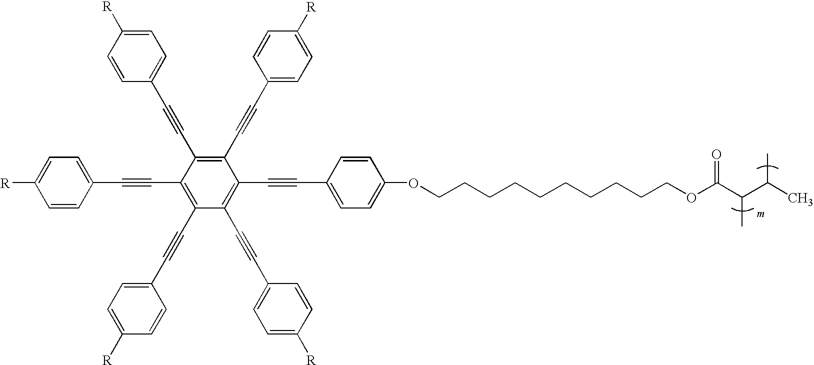

| | R |
|---|---|
| DSP-63 | —OC₂H₄OC₈H₁₇ |
| DSP-64 | —OC₁₂H₂₅ |

| | |
|---|---|
| | [Formula 32] |
| 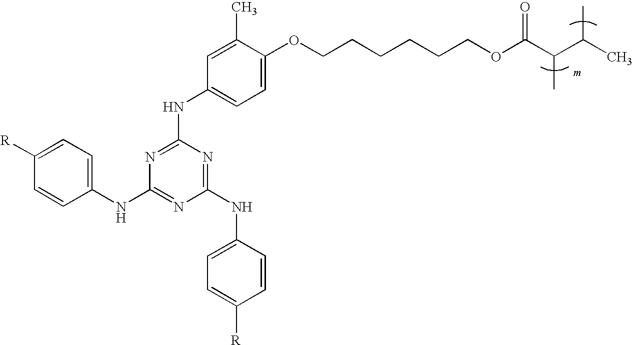 | |

| | R |
|---|---|
| DSP-65 | —OC₈H₁₇ |
| DSP-66 | —OC₁₆H₃₃ |

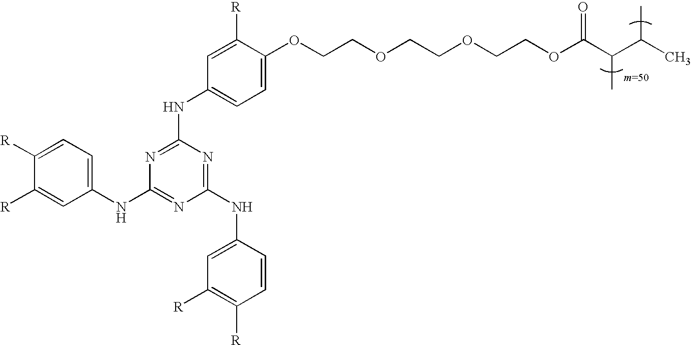

| | R |
|---|---|
| DSP-67 | —OC₈H₁₇ |
| DSP-68 | —OC₁₆H₃₃ |

### [Method of Synthesizing Polymer]

The polymer having at least one species of repeating unit having a mesogen group may be produced by combining publicly-known methods of organic synthesis and methods of polymerization. The mesogen structure may be introduced into the polymer molecule, after the polymer was obtained by polymerization. The polymer may be produced by polymerizing mesogen structure-containing monomers. For example, the mesogen structure may be introduced, after (meth)acrylates are polymerized, into the carboxylic acid portions of the polymer, by esterifying reaction. The mesogen structure may be introduced to the ester portion of (meth)acrylate esters, and then polymerization of the obtained monomer may be carried out. More specifically, the synthetic methods may be exemplified by those described in Macromol. Chem., Rapid Commun., 4, 807-815 (1983), Macromol. Chem., Rapid Commun., 6, 367-373 (1985), Macromol. Chem., Rapid Commun., 6, 577 (1985), J. Chem. Soc. Perkin Trans., I, 1995, p. 829., Liquid Crystals, 1995, Vol. 18, No. 2, p. 191, Liquid Crystals, 1998, Vol. 25, No. 1, p. 47, and J. Mater. Chem., 1998, 8(1), p. 47.

The polymer having the mesogen group in the main chain thereof may be polyester, and may be, for example, polyester obtained by allowing a monomer substituted by two ester groups to react with a diol in a condensing manner.

Weight-average molecular weight of the polymer is preferably 5,000 to 400,000, more preferably 5,000 to 200,000, still more preferably 20,000 to 200,000, and further more preferably 50,000 to 150,000. The weight-average molecular weight of the polymer kept fallen in the above-described ranges is preferable in view of ensuring an excellent shearing stability under high temperatures and high pressures. It is to be noted that the weight-average molecular weight or the polymer was measured by GPC.

[Formation of Complex with Triarylmelamine Polymer]

The lubricant composition of the present invention may comprise at least one species of compounds represented by the formula (4)-a, b, c, d, e, f or g below:

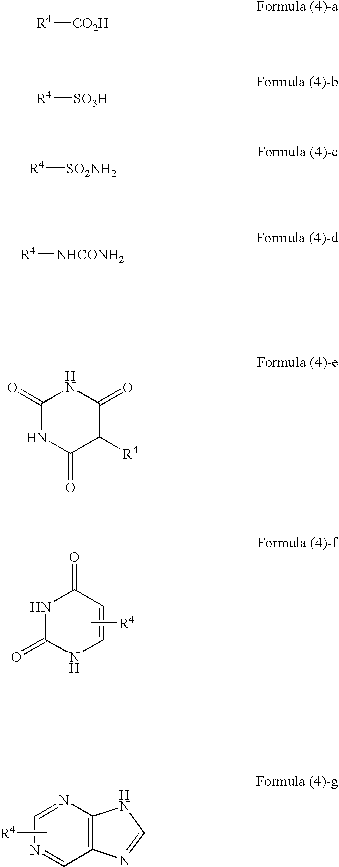

In the formulae, R⁴ represents a substituted alkyl group, phenyl group or heterocyclic group, wherein they have a substituent containing at least one divalent C₈ or longer alkylene group, oligoalkyleneoxy chain, oligosiloxy chain, oligoperfluoroalkyleneoxy chain or disulfide group.

A compound represented by the above-described formula (1-2) or (2-2) in which at least one R¹ of the triarylmelamine core is a hydrogen atom may form a complex with the compound represented by the formula (4) via a hydrogen bond (see Liquid Crystals, 1998, Vol. 24, No. 3, p. 407-411), so that the polymer drastically varies its solubility and glass transition point, and the phase transition temperature if the polymer is a liquid crystal. Therefore the performance of improving viscosity index, friction lowering property, and anti-wearing property may further be improved. In an embodiment containing a compound represented by any of the above-described formulae (4)-a to g, the compound may preferably be contained to an equivalence of 0.1 to 6 relative to the mesogen group of the polymer, and more preferably to an equivalence of 0.5 to 1.5.

Specific examples of the compounds represented by the above-described formulae (4)-a to g include, however are not limited to, those shown below.

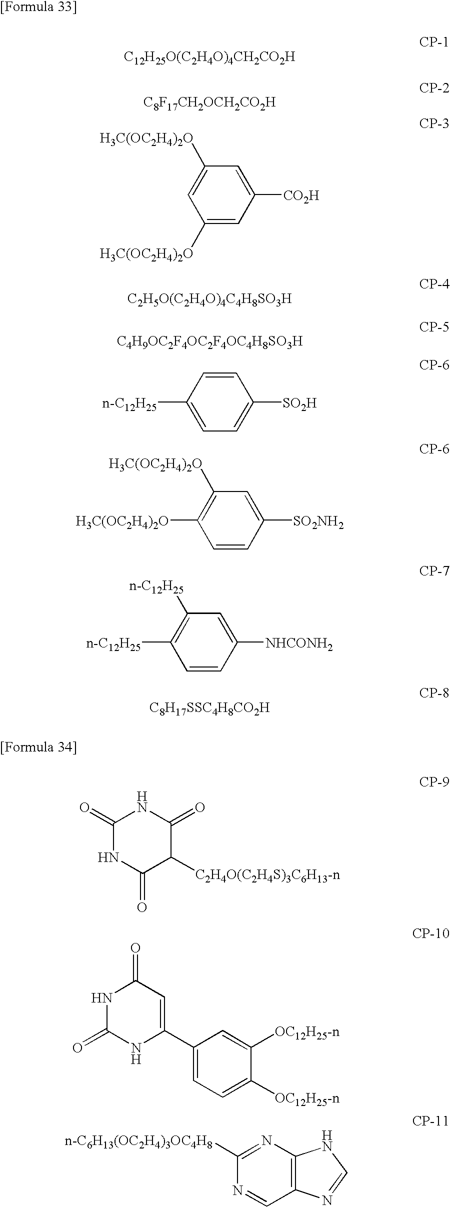

### [Function of Improving Viscosity Index]

As has been described in RELATED ART section, solubility of the viscosity index improver into oil may improve as temperature rises, the polymer chains entangled at low temperatures may be resolved to show a larger diffusion sectional area, which may develop the effect of increasing the viscosity, and consequently viscosity of the oil as a whole may be increased.

Larger viscosity index means higher performance of the viscosity index improver. For an exemplary case where a mineral oil is used as the base oil, and if a sample added with 5% by mass to 30% by mass of a certain agent should show a viscosity index of 100 or larger, the agent may be understood as the viscosity index improver. When the polymerization agent is used as the viscosity index improver, the viscosity index measured under the above-described conditions is preferably 120 or larger, more preferably 140 or larger, and still more preferably 160 or larger. The viscosity index may be measured by the method specified by JIS (JIS K2283).

In the conventional technique, the temperature dependence of solubility of the viscosity index improver may be ascribed to methacrylate moieties capable of forming a relatively rigid main chain, whereas the solubility into oil maybe ascribed to long-chain alkyl group composing the side chains. According to the present invention, it is expected that the rigidity may be maintained by the mesogen structure partially playing a role of the main chain, and that alignment thereof under shearing may further improve the anti-shearing property by virtue of Miesowicz low viscosity. Employing the polymer in combination of base oil, terminal chains preferably substituted on the mesogen may be determined depending on the base oil to be employed together in terms of solubility, and generally those having chemical structures similar to that of the base oil are preferably used. For mineral oils or chemically synthesized oils such as poly α-olefins, the side chains may be selected from long-chain alkyl groups. For liquid crystalline compounds having radially arranged side chains, the hydrophilicity or hydrophobicity thereof tends to be expressed generally as a result of hydrophilicity or hydrophobicity of the terminal groups of the side chains, so that the solubility may be controlled by long alkyl groups binding to the terminal portions; and in terms of improving the viscosity index, performance may be controlled in the same manner.

For fluorine-containing base oil, the side chain may be selected from perfluoroalkyl groups and oligoperfluoroalkyleneoxy groups.

For water-base base oil, the side chain may be selected from oligoalkyleneoxy groups.

Selection of the side chain substituents in terms of solubility is preferably adopted also to the selection of the structure of the main chain.

### [Technique of Developing Lubricating Performance (Friction Modifying Performance)]

For development of low friction property and anti-wearing property, which are intrinsic lubricating functions, a discotic or planar mesogen structure having radially-arranged side chains is preferable. These functions are, however, effective when they are localized in the vicinity of the mutually sliding boundaries, so that, unlike the conditions under which the function of improving viscosity index is developed, the polymer as being homogeneously dispersed in a form of micro-particles in the base oil, rather than being dissolved therein, can function more effectively only with a small content in the base oil. The polymer may, therefore, be used alone, without mixing typically with a hydrocarbon-base base oil. In this mode of embodiment, the polymer may be a major component of the lubricant composition, and for example, the lubricant composition of the present invention may be composed only of the polymer. On the other hand, in another mode of embodiment in which the polymer is used in combination with the base oil such as lubricating oil as described below, content of the polymer is preferably 0.1 to 30% by mass of the total mass, more preferably 0.5 to 15% by mass, and still more preferably 1 to 5% by mass.

The lubricant composition of the present invention may contain, together with the polymer, a lubricating oil as the base oil. In a mode of embodiment further containing the lubricating oil, content of the lubricating oil is preferably 70 to 99.9% by mass of the total mass.

### [Base Oil]

An oily material (lubricating oil) applicable to the base oil of the lubricant composition of the present invention may be one species, or two or more species selected from general mineral oils and synthetic oils having been used for base oil of conventional lubricating oil compositions. For example, any of mineral oil, synthetic oil, or mixed oil of them may be used. The mineral oil is exemplified by solvent-purified raffinate obtained by extracting raw material of lubricating oil derived by distillation under normal pressure or reduced pressure of paraffin-base, intermediate-base or naphthene-base crude oil using an aromatic extraction solvent such as phenol, furfural or N-methylpyrrolidone; hydrogen-treated oil obtained by bringing raw material of lubricating oil into contact with hydrogen, under the presence of a hydrogen treatment catalyst such as cobalt or molybdenum held by silica-alumina; hydrocracked oil obtained by bringing the raw material into contact with hydrogen, under the presence of a hydrocracking catalyst under severe conditions for cracking; isomerized oil obtained by bringing wax into contact with hydrogen, under the presence of an isomerization catalyst under conditions for isomerization; and distillation fraction of lubricating oil obtained by combinations of solvent purification process with hydrogen treatment process, hydrocracking process, isomerization process and so forth. In particular, high-viscosity-index mineral oil obtained by the hydrocracking process or isomerization process may be exemplified as a preferable product. In any method of the manufacturing, processes such as dewaxing, hydrofinishing, clay treatment process and so forth may arbitrarily be selectable according to general procedures. Specific examples of mineral oil include light neutral oil, medium neutral oil, heavy neutral oil, bright stock and so forth, wherein the base oil may be prepared by arbitrary mixing these oils so as to satisfy desired performances. The synthetic oil may be exemplified by poly(α-olefin), α-olefin oligomer, polybutene, alkylbenzene, polyol ester, dibasic acid ester, polyoxyalkylene glycol, polyoxyalkylene glycol ether, silicone oil and so forth. These base oils may be used independently, or in combination of two or more species thereof. It is also allowable to use the mineral oil and the synthetic oil.

For the case where the polymer containing the mesogen structure as repeating unit is contained in a dispersed manner, the lubricant composition of the present invention preferably contains 0.01 to 30 parts by mass of polymer and 99.99 to 70 parts by mass of the oily substance, and more preferably contains 5 to 20 parts by mass of the polymer and 95 to 80 parts by mass of the oily substance. The content of the polymer adjusted to the above-described ranges is preferable in view of developing the fuel saving property and low friction property over a wide output range. On the other hand, for the case where the lubricant composition of the present invention contains the polymer containing the mesogen structure as repeating unit in a dissolved form, the lubricant composition preferably contains 1 part by mass or more of polymer per 100 parts by mass of the base oil, and more preferably contains 5 parts by mass or more of polymer. The content of the polymer adjusted to the above-described ranges is preferable in view of expressing the effect of improving viscosity index and shearing stability thereof over a wide output range.

### [Micro-Dispersion Technique]

The base oil is available generally at low prices, has low viscosity, ensures small torque during operation of sliding machines, and shows extremely small viscosity index in fluid lubrication under small load, so that it is preferable to add a small amount of polymer to the base oil. The polymer used as being undissolved into the base oil, aiming at allowing the polymer to segregate at the boundaries of sites of sliding, however, often degrades efficiency of segregation at the sites of sliding in general. Even if the polymer should successfully segregate in the vicinity thereof, it may generally be preferable for the polymer to have a mean particle size of 50 μm or smaller, and more preferably 10 μm or smaller, in view of allowing it to enter a narrow gap of sliding. It is therefore preferable that the polymer having such mean particle size is homogeneously dispersed in the base oil. By virtue of this configuration, the polymer becomes extremely accessible to the real sites of sliding, spreads to form a film by the shearing force applied from both sides thereof, covers the sliding surfaces, and additionally expresses the effect of reducing the surface roughness, and can thereby enhance the low friction property and anti-wearing property.

The polymer may be dispersed into an organic solvent or water. More specifically, examples of the methods include a method of allowing the polymer, under co-existence of the base oil and a dispersant, to micronize and disperse by shearing force applied in the state of fluid film by a homogenizer or the like, a method of attaining micro-dispersion with the aid of ultrasonic wave, and a method of homogeneously dispersing micro-particles of the polymer, by carrying out polymerization of monomers of the polymer while being dispersed in an organic solvent or water, under co-existence of a dispersant. Because the polymer to be dispersed into base oil or water is preferably insoluble to them, it is necessary to employ factors absolutely opposite to the above-described molecular design aimed at development of the effect of improving viscosity index. Employing hydrocarbon-base solvent as base oil, it is preferable to use, for the side chains or the main chain portions, a less-compatible perfluoroalkylene group, oligoperfluoroalkyleneoxy group, or oligoalkyleneoxy group, to an amount relatively larger than that of long-chain alkylene groups. On the other hand, employing water-base base oil, it is preferable to use a relatively larger amount of less-compatible perfluoroalkylene group, oligoperfluoroalkyleneoxy group, long-chain alkylene group, polysiloxane group.

In any case, a dispersant to be brought into co-existence holds the key. Details of this technique is described in K. J. Barrett, “Dispersion Polymerization in Organic Media”, published by JOHN WILEY & SONS. Co-existence of the solvent and the micro-particle-size polymer incompatible therewith generally raises a strong tendency of allowing the polymer micro-particles to aggregate and precipitate, so that it is necessary for the dispersant to be amphipatic, that is, to have a polymerized structure containing both partial structures incompatible to each other.

Still more preferably, oligomer or polymer of these partial structures may be block copolymer or graft copolymer. They are exemplified by poly(2-ethylhexyl acrylate-g-vinyl acetate), poly(12-hydroxy stearate-g-glycidyl methacrylate), poly(lauryl methacrylate b-methacrylic acid), poly(styrene-b-dimethylsiloxane), poly(2-ethyl hexyl acrylate-g-methylmethacrylate), poly(styrene-b-methacrylic acid), poly(butadiene-b-methacrylic acid), poly(styrene-b-t-butylstyrene), poly(lauryl methacrylate b-hexaethyleneoxyethylmethacrylate), poly(lauryl methacrylate b-hexa(perfluoroethyleneoxy)ethyl methacrylate), and poly(3-hexyldecyl methacrylate b-3-ureidopropylmethacrylate).

The polymer may be dispersed into a water-base solvent. Although technique of water base dispersion generally adopted is emulsion polymerization allowing polymerization to proceed after dispersion by emulsification, dispersion polymerization is also adoptable, by which monomers dissolved in a mixed solvent of water and water-soluble organic solvent are polymerized under the presence of a detergent while keeping small particle sizes, and stably dispersed with the aid of detergent as being insolubilized and deposited, and the water-soluble organic solvent is removed if necessary.

### [Additives]

Besides these, for the purpose of ensuring practical performances adapted to various applications, the lubricant composition of the present invention may appropriately be added with various additives used for lubricants such as bearing oil, gear oil and transmission oil, such as anti-wearing agent, extreme pressure agent, antioxidant, viscosity index improver, detergent-dispersant, metal deactivator, anti-corrosion agent, rust preventives, and defoaming agent, if necessary, so far as effects of the present invention will not be impaired.

### [Lubrication Film]

The lubricant composition of the present invention may be coated on surfaces so as to use it as a lubrication film. The thickness thereof in this case is affected by roughness of the surface to be coated, wherein a thickness of 5 μm or around ensures desirable levels of low friction property and anti-wearing property for a surface roughness of 0.5 μm, and a thickness of 0.03 μm or around similarly ensures desirable performances for a surface roughness of 0.02 μm.

Alternatively, similarly to a technique of forming the lubrication film by adding a solid lubricant to a binder polymer, the lubricant composition of the present invention may be added with a solid lubricant, so as to form the lubrication film.

The solid lubricant may be exemplified by polytetrafluoroethylene, molybdenum disulfide, tungsten disulfide, graphite, organic molybdenum compound, and boron nitride.

Alternatively, a binder polymer may be added. As the binder polymer, organic resin may be exemplified by thermosetting resins such as epoxy resin, polyimide resin, polycarbodiimide resin, polyethersulfone, polyether ether ketone resin, phenol resin, furan resin, urea resin, and acryl resin; and inorganic polymer may be exemplified by film-forming materials having three-dimensional crosslinked structures of metal-oxygen bond such as Ti—O, Si—O, Zr—O, Mn—O, Ce—O and Ba—O.

### [Substrate]

The lubrication film may be formed on the surfaces of various substrates. Materials composing the substrate may be exemplified by ceramics such as silicon carbide, silicon nitride, alumina and zirconia; cast iron; copper, copper-lead and aluminum alloys and cast products thereof; white metal; various plastics such as high-density polyethylene (HDPE), tetrafluoroethylene resin (PFPE), polyacetal (POM), polyphenylene sulfide (PPS), polyether ether ketone (PEEK), polyamide-imide (PAI) and polyimide (PI); organic-inorganic composite material combining plastics with fiber composed of glass, carbon or aramid; and cermet which is composite material of ceramics and metals.

Besides the above-described resins and ceramics, it is also preferable to use materials having a diamond-like carbon film formed on the surface of machine-structural alloyed steel, structure-mechanical alloyed steel such as nickel-chromium steel, nickel-chromium-molybdenum steel, chromium steel, chromium-molybdenum steel, and aluminum-chromium-molybdenum steel.

Alternatively, still other examples include sintered metal having on the surface thereof a porous layer formed by sintering copper-base metal powder, and having a lubricant composition impregnated therein; porous ceramics typically formed based on strong binding of fine particles of calcium zirconate (CaZrO₃) and magnesia (MgO); porous glass obtained by thermally inducing phase separation between silica and borate-base component; sintered porous mold product of ultra-high-molecular-weight polyethylene powder; porous film composed of fluorine-containing-resin such as tetrafluoroethylene; polysulfone-base porous film used for micro-filter and so forth; and porous film formed by preliminarily inducing phase separation between a poor solvent of a mold product and a monomer for forming the mold product during the polymerization.

### [Solid Lubricant]

Of the above-described polymers, those having high glass transition points may be used as the solid lubricant after being pulverized. The solid lubricant may be used alone, or may be used as being dispersed or dissolved into a binder.

Low friction property and anti-wearing property may be developed, also by adding 20 to 40 parts by mass of base oil per 100 parts by mass of polymer, and using them as being dissolved with each other.

### [Applications]

The lubricant composition of the present invention may be used for various applications. For example, engine oils and gear oils for vehicles including automobiles, hydraulic oil for automobiles, lubricating oil for marine vessels/aircrafts, machine oil, turbine oil, bearing oil, hydraulic fluid, oil for compressor/vacuum pump, freezer oil and lubricating oil for metal working, lubricant for magnetic recording media, lubricant for micro-machines, and lubricant for artificial bone.

### EXAMPLES

The present invention will further specifically be explained referring to Examples below. The materials, reagents, ratios, operations and so forth shown below may appropriately be modified without departing from the spirit of the present invention. The scope of the present invention is by no means limited to Examples shown below.

### Example 1-1

### Preparation of Polymer Having Mesogen Structure (Including Discotic Structure) in the Main Chain

General methods of synthesizing triphenylene rings (Exemplary Compounds DMP-1 to 13) as the mesogen structure are detailed in Liquid Crystals., Vol. 31, No. 8, p. 1037 (2004) and the cited references thereof, wherein the methods of synthesis may vary depending on bonding modes between the main chains of the polymer.

For example, as for Exemplary Compounds DMP-1 to 8, and DMP-52 to 58, the mesogen rings were combined in the same manner as the synthetic method described in Makromol. Chem. Rapid Commun., Vol. 6, p. 577 (1985).

As for Exemplary Compounds DMP-9 to 18, DMP-21 to 25, DMP-35 to 44, and DMP-49 to 51, the mesogen rings were combined in the same manner as the method described in Macromolecules, Vol. 23, p. 4061 (1990).

As for Exemplary Compounds DMN-26, 27, 30, and DMP-45 to 48, the mesogen rings were combined in the same manner as the method described in J. Chem. Soc. Perkin Trans., I, p. 829 (1995).

Hexa-substituted benzene ring (Exemplary Compound DMP-55) was synthesized conforming to the method described in Makromol. Chem. Rapid Commun., Vol. 6, p. 367 (1985). Tri-substituted benzene ring (Exemplary Compounds DMP-56 and 57) was synthesized conforming to the method described in Liquid Crystals., Vol. 26, No. 10, p. 1501 (1999).

Triaryl melamine rings (Exemplary Compounds DMP-31 to 48) were synthesized conforming to the method described in Liquid Crystals., Vol. 24, No. 3, p. 407 (1998).

Hexaethynylbenzene rings (Exemplary Compounds DMP-49 to 51) were synthesized conforming to the method described in Angew. Chem. Int. Ed., Vol. 39, No. 17, p. 3140 (2000).

Phthalocyanine rings (Exemplary Compounds DMP-52 to 54) were synthesized conforming to the method described in Japanese Laid-Open Patent Publication No. 2000-119652.

### 1. Evaluation of Effect of Improving Viscosity Index of Highly-Soluble Discotic Polymer

### Examples 1-2 to 16, Comparative Examples 1-1 to 3, Referential Examples 1-1 and 1-2

### Preparation of Lubricating Oil and Evaluation of Effect of Improving Viscosity Index of Highly-Soluble Discotic Polymer

Five parts by mass of the polymers having the mesogen structures obtained in Example 1-1 and 95 parts by mass of Super Oil N-32 (from Nippon Steel Chemical Co., Ltd.) as the base oil for lubricating oil were heated to 100° C. under microscopes (microscopic heating device FP-80HT Hot Stage from Mettler Inc., and OPTIPHOT-POL from Nikon Corporation) at a 400× magnification, and 15 parts by mass of those confirmed that an extremely small amount of micro-solid matters seen at 40° C. were completely dissolved when heated to 100° C. (DMP-3, 10, 15, 21, 30, 31, 35, 44, 51, 52, 55, 56, 59, 60, 61) were mixed with 85 parts by mass of N-32, to thereby prepare lubricant compositions.

As Comparative Examples, lubricant compositions were prepared according to a similar method, respectively using a polymethacrylate-base viscosity index improver (CP-1) and a viscosity index improver (CP-2) composed of an ethylene-maleic anhydride grafted amine modified product.

Each of thus prepared lubricant compositions was evaluated as follows:

### (Function of Improving Viscosity Index)

Dynamic viscosity (at 100° C. and 40° C.) of the lubricant compositions of Examples 1-2 to 16, Comparative Examples 1-1 to 3, and Referential Examples 1-1 and 2 were measured using an Ubbelohde viscometer, and viscosity indices were calculated conforming to JIS K2283. Viscosity of Super Oil N-32 (from Nippon Steel Chemical Co., Ltd.) used for preparing the lubricant composition (that is, lubricating oil before being added with the discotic polymers) was found to be 30.6 mm²/s at 40° C., and 5.31 mm²/s at 100° C., and viscosity index was found to be 106.

### (Shearing Stability (Rate of Decrease in Viscosity))

According to JASO Standards M347-95 issued by Society of Automotive Engineers of Japan, the lubricant compositions of Examples 1-2 to 16, Comparative Examples 1-1 to 3, and Referential Examples 1-1 and 2 were irradiated with ultrasonic wave at 100° C. for a specified duration of time. The viscosity after the irradiation was measured, and rate of decrease in viscosity of the lubricant compositions was measured based on the viscosity values obtained before and after the irradiation. Smaller rate of decrease in viscosity of the lubricant composition means larger shearing stability of the viscosity index improver.

TABLE 1-1

| | | Dynamic | Dynamic | | Rate of |
|---|---|---|---|---|---|
| | | viscosity | viscosity | | decrease in |
| | Material | at | at | Vis- | dynamic |
| Example | added | 40° C. | 100° C. | cosity | viscosity at |
| No. | to N-32 | [mm²/s] | [mm²/s] | index | 100° C. [%] |
| 1-2 | DMP-3 | 52.4 | 8.88 | 149 | 0.3 |
| 1-3 | DMP-10 | 66.6 | 11.3 | 164 | 0.5 |
| 1-4 | DMP-15 | 87.2 | 14.2 | 167 | 0.3 |
| 1-5 | DMP-21 | 95.7 | 14.8 | 162 | 0.4 |
| 1-6 | DMP-30 | 52.1 | 8.86 | 149 | 0.3 |
| 1-7 | DMP-31 | 93.2 | 14.5 | 163 | 0.6 |
| 1-8 | DMP-35 | 94.1 | 14.6 | 162 | 0.3 |
| 1-9 | DMP-44 | 77.7 | 12.2 | 161 | 0.3 |
| 1-10 | DMP-51 | 96.9 | 15.5 | 171 | 0.3 |
| 1-11 | DMP-52 | 77.9 | 12.0 | 149 | 0.5 |
| 1-12 | DMP-55 | 59.4 | 10.1 | 159 | 0.4 |
| 1-13 | DMP-56 | 95.8 | 14.4 | 155 | 0.3 |
| 1-14 | DMP-59 | 66.9 | 11.3 | 163 | 0.5 |
| 1-15 | DMP-60 | 93.2 | 14.5 | 163 | 0.5 |
| 1-16 | DMP-61 | 78.2 | 12.9 | 166 | 0.2 |
| z | — | 30.6 | 5.31 | 106 | — |
| Comparative | CP-1 | 100.2 | 14.2 | 145 | 0.8 |
| Example | | | | | |
| 1-2 | | | | | |
| Comparative | CP-2 | 101 | 15.5 | 162 | 1.2 |
| Example | | | | | |
| 1-3 | | | | | |
| Referential | DMP-8 | 65.5 | 9.2 | 119 | — |
| Example | | | | | |
| 1-1 | | | | | |
| Referential | DMP-39 | 82.1 | 10.6 | 113 | — |
| Example | | | | | |
| 1-2 | | | | | |

From the results shown in Table 1-1, it is understandable that, of the discotic polymers having the mesogen structure in the main chains thereof, those having large solubility at 100° C. (Examples 1-2 to 16) generally show high viscosity indices equivalent to those of general viscosity index improvers, whereas those having poor solubility (Referential Examples 1-1 and 2) show the values not so different from the viscosity index of the base oil itself. In short, the results suggest that the function of viscosity index improver making use of temperature-dependent difference between solubility and insolubility may be developed through a similar mechanism, also by the lubricant compositions containing the discotic polymers.

Also as for shearing stability, it may be understood that the discotic polymers show small rate of decrease in viscosity index, and have desirable properties as the viscosity index improver.

### 2. Evaluation of Various Performances Relating to Function of Improving Viscosity Indices of Highly-Soluble Samples

### Examples 1-17 and 18, Comparative Examples 1-6 and 7

### Evaluation of Various Performances Relating to Function of Improving Viscosity Indices of Highly-Soluble Samples

Fifteen parts by mass of discotic polymers DMP-15, DMP-35, and CP-1, CP-2 for comparison, and 85 parts by mass of N-32 were respectively mixed to thereby prepare the lubricant compositions.

Various performances relating to performance of improving viscosity indices were evaluated similarly to as in Example in the above. Results are shown in Table 1-2 and Table 1-3.

### (Viscosity Properties at Low Temperatures)

MRV (mini-rotary viscometer), CCS (cold-cranking simulator) and TP-1 of thus prepared lubricant compositions were respectively measured. Results are shown in Table 1-2. The MRV, CCS and TP-1 are values expressing viscosity properties of composition at low temperatures.

MRV (mini-rotary viscometer) is measured according to a method described in ASTM-D3829, wherein viscosity is measured on the centipoise basis. Measurement temperature is −25° C.

CCS (cold-cranking simulator) is measured according to the method described in SAE J300 Appendix, wherein viscosity values under high shearing is measured on the centipoise basis. The test relates to resistivity of lubricating oil against cold-start of engine. The higher the CCS becomes, the larger the resistivity of oil against cold-start of engine becomes.

TP-1 is measured according to the method described in ASTM-D4684. This is substantially equivalent to MRV, except that gradual cooling cycle is adopted. The cycle is specified by SAE Paper No. 85 0443 (K. O. Henderson).

### (Sludge Dispersion)

Sludge dispersibility of thus prepared lubricating oils was tested. Criteria for judgment are shown below:

∘ . . . no sedimentation of sludge observed;

Δ . . . slight sedimentation of sludge observer; and

x . . . sedimentation of sludge observed.

Results of the test are shown in Table 1-2.

TABLE 1-2

| | | Viscosity property | | | |
|---|---|---|---|---|---|
| | Viscosity | at low temperatures | | | |
| Example | index | MRV | CCS | TP-1 | Sludge |
| No. | improver | (cP) | (cP) | (cP) | dispersibility |
| 1-17 | DMP-15 | 12,635 | 2,885 | 12,001 | ◯ |
| 1-18 | DMP-35 | 11,980 | 2,639 | 11,942 | ◯ |
| Comparative | CP-1 | 13,394 | 2,887 | 12,309 | X |
| Example 1-6 | | | | | |
| Comparative | CP-2 | 16,688 | 3,514 | 14,248 | Δ |
| Example 1-7 | | | | | |

It is understandable from the results shown in Table 1-2 that the lubricant compositions of Examples 1-17 and 18 were superior to the lubricant compositions of Comparative Examples 1-6 and 7, in all viscosity properties at low temperatures in terms of MRV, CCS and TP-1.

Also as for sludge dispersibility, the lubricant compositions of Examples 1-17 and 18 were found to be superior to the lubricant compositions of Comparative Examples 1-6 and 7.

### Examples 1-19 and 20, Comparative Examples 1-8 and 9

### Preparation and Evaluation of Lubricant Compositions

### (Method of Testing Anti-Oxidative Property)

Ten parts by mass each of DP-15 and DP-35 were homogenously dissolved into 90 parts by mass of 100-neutral mineral oil to thereby prepare the lubricant compositions. Also the lubricant compositions shown in the Table below were prepared respectively using CP-1 and CP-2, according to the same method.

Thus prepared lubricant compositions were subjected to anti-oxidative test at 165.5° C. for 98 hours conforming to JIS-K2514, and the amount of production of sludge was measured by the B method. The B method herein refers to a method measuring the amount of sludge precipitated by centrifugation from the tested lubricating oils added with a sludge flocculant, wherein the amount of sludge determined by the B method indicates the anti-oxidant property.

### (Carbon Black Dispersibility Test)

In a sample container for anti-emulsification property test (JISK2839), 0.3 g of carbon black was placed, and each of solutions obtained by respectively adding 3% by weight each of DMP-15 and DMP-35 synthesized in Example 1-1, and the additives (CP-1) and (CP-2) used in Comparative Examples 1-6 and 7 to 60-neutral mineral oil, was added so as to adjust the total volume to 80 ml, to thereby prepare the compositions shown in Table below. Each mixture was stirred using an anti-emulsification tester (JISK2520) at 30° C., 1,500 rpm for 5 minutes, 75 ml of the mixture was then transferred to a 100-ml centrifugal tube, centrifuged at 2,000 rpm for 20 minutes, the supernatant was diluted by a factor of 60 with the 60-neutral mineral oil, and absorbance at a wavelength of 750 nm was measured. Larger absorbance means better dispersibility, and indicates smaller amount of sludge produced by oxidation, and correlates with cleaning-dispersing performance. Results are shown in Table 1-3.

TABLE 1-3

| | | Viscosity at | | |
|---|---|---|---|---|
| Example | Viscosity index | −40° C. | Amount of | |
| No. | improver | (cSt) | sludge (%) | Absorbance |
| 1-19 | DMP-15 | 39,500 | 0.9 | 0.62 |
| 1-20 | DMP-35 | 40,000 | 1.2 | 0.67 |
| Comparative | CP-1 | 47,000 | 2.5 | 0.23 |
| Example | | | | |
| 1-8 | | | | |
| Comparative | CP-2 | 44,000 | 1.6 | 0.15 |
| Example | | | | |
| 1-9 | | | | |

From the results shown in Table 1-3, it is understandable that DMP-15 and DMP-35 are far better in dispersibility as compared with the conventional viscosity index improvers CP-1 and CP-2, in other words, excellent in the anti-oxidative property and cleaning-dispersing performance.

The polymer having the mesogen group in the main chain thereof has low-temperature viscosity characteristics and anti-oxidative characteristics better than those of methacrylic polymer having been used conventionally as the viscosity index improver. The lubricant compositions of the present invention containing such polymer are, therefore, excellent in the fluidity characteristics at low temperatures and anti-oxidative stability at high temperatures, and may be used even under severe environment.

### Examples 1-21 and 22, Comparative Examples 1-10 and 11

### Preparation and Evaluation of Lubricant Compositions (Traction Coefficient)

The lubricant compositions were respectively prepared by blending 8.3% each of DMP-15 and DMP-35, 11% of engine oil package (for SH standard oil) and 80.7% of general 100-neutral mineral oil, and viscosity at 100° C. necessarily be taken into consideration for engine oil was adjusted to 10.0 to 10.4 cSt. As Comparative Examples, the lubricant compositions were respectively prepared by blending 4.3% each of the viscosity index improver CP-1, and 1% or none of molybdenum thiocarbamate-base FM agent (Molyvan A, from Vanderbilt Co., Inc.), with which 11% of engine oil package (SH standard oil) and general 100-neutral mineral oil were blended, and viscosity at 100° C. necessarily be taken into consideration for engine oil was respectively adjusted to 10.0 to 10.4 cSt, to thereby prepare the lubricant compositions. Coefficients of friction of these samples were measured using SRV friction-and-wear tester under conditions including a temperature of 80° C., a load of 50 N, and a frequency of 50 Hz, and results shown in Table 1-4 were obtained.

TABLE 1-4

| Example | | | |
|---|---|---|---|
| No. | | FM Agent | Traction coefficient |
| 1-21 | DMP-15 | not added | 0.115 |
| 1-22 | DMP-35 | not added | 0.110 |
| Comparative | CP-1 | not added | 0.159 |
| Example | | | |
| 1-10 | | | |
| Comparative | CP-1 | added | 0.055 |
| Example | | | |
| 1-11 | | | |

From the results shown in Table 1-4, it was confirmed that significant effects of reducing traction were obtained by addition of polymers (discotic polymers) DMP-15 and DMP-35 having the mesogen groups. It is therefore understandable that the lubricant compositions of the present invention may be excellent in the fuel saving property.

### Examples 1-23 and 24, Comparative Example 1-12

### Preparation and Evaluation of Lubricant Compositions

An OCP-base viscosity index improver (Orpheus M-1210, from Mitsui Petro-Chemical Industry Co.) composed of ethylene-propylene copolymer was used under the name of CP-3.

Five percent each of the discotic polymers DMP-15, DMP-35, and viscosity index improver CP-3, and 5% of DI package for CD-grade Diesel engine oil were added to solvent-refined oil A (150-neutral oil with a viscosity index of 100) and solvent-refined oil B (200-neutral oil with a viscosity index of 100), to thereby prepare engine oils (lubricant compositions) corresponded to Example 1-23, Example 1-24 and Comparative Example 1-12 shown in Table 1-5 below. In this case, amounts of mixing of the solvent-refined oils A and B were adjusted so as to make dynamic viscosity at 100° C. fall in the range from 10.0 to 10.4 cSt, and so as to adjust CCS viscosity at −20° C. to 3,000 cP. These engine oils were subjected to panel coking test and anti-oxidative stability test. Results are shown in Table 1-5. TBS viscosity (150° C., at a shearing speed of 10⁶/sec) and viscosity index relevant to fuel saving property were shown in Table 1-5.

### (Method of Panel Coking Test)

Three types of engine oils described in the above were subjected to panel coking test according to the method of panel coking test Fed-791B, at a panel temperature of 300° C., a temperature of engine oil of 100° C. for 4 hours. After the test, the panels were cleaned with pentane, and the amount of coking was measured by a gravimetric method.

### (Method of Anti-Oxidative Stability Test)

Three types of the above-described engine oils were subjected to the anti-oxidative stability test according to JIS-K2514, at 165.5° C. for 96 hours. The amount of increase in the total acid based on the values before and after the test was measured.

TABLE 1-5

| | | | Anti-oxidative | | |
|---|---|---|---|---|---|
| | | Amount | stability based on | | |
| | Viscosity | of | amount of increase | TBS | Vis- |
| Example | index | coking | in total acid value | viscosity | cosity |
| No. | improver | [mg] | [mgKOH/g] | [mPa · s] | index |
| 1-23 | DMP-15 | 51 | 1.9 | 2.77 | 162 |
| 1-24 | DMP-35 | 47 | 1.4 | 2.83 | 152 |
| Com- | CP-1 | 83 | 2.8 | 3.15 | 150 |
| parative | | | | | |
| Example | | | | | |
| 1-12 | | | | | |

From the results shown in Table 1-5., it is understandable that the engine oils using the polymers (discotic polymers) DMP-15 and 35 having the mesogen groups showed smaller amounts of coking as compared with those shown by the OCP-base viscosity index improvers which was considered as producing only small amounts of coking (Comparative Example 1-12). It is also understandable that these oils are low in the TBS viscosity, and have equivalent or larger viscosity indices.

### 3. Functional Evaluation of Low Friction Property of Sample Less Soluble to Base Oil

### Examples 1-25 to 42 and Comparative Examples 1-13 to 16

### Low Friction Property and Anti-Wearing Function of Discotic Polymer Micro-Dispersed in Base Oil

Five parts by mass of the discotic polymers obtained in Example 1-1 and 95 parts by mass of Super Oil N-32 (from Nippon Steel Chemical Co., Ltd.) as the base oil for lubricating oil were heated to 100° C. under microscopes (microscopic heating device FP-80HT Hot Stage from Mettler Inc., and OPTIPHOT-POL from Nikon Corporation) at a 400× magnification, and 5 parts by mass of the compounds less soluble to the base oil, showing almost no changes in the state of dispersion of micro-solid matters between 40° C. and 100° C. (besides DMP-8, 39, also DMP-6, 7, 12, 19, 22, 24, 27, 28, 29, 38, 41, 45, 47, 48, 53, 57) were mixed with 95 parts by mass of N-32, to thereby prepare lubricant compositions. The lubricant compositions were further added with 0.5 parts by mass of a block copolymer, and was then homogenized using an ultrasonic homogenizer, to thereby prepare the lubricant compositions having the discotic polymers stabilized therein while keeping a micro-dispersion state with a particle size of 0.5 μm.

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 65 μm in surface roughness, both of which being made of SUJ-2 steel.

On the disk, 120 mg of each of the above-described lubricant compositions was placed, the load was applied to the cylinder, and the coefficient of friction over 40° C. to 110° C. was measured under the above-described conditions of reciprocative sliding.

For comparison, coefficients of friction were measured also for N-32 base oil, N-32 base oil+BCP-1, and N-32 base oil+CP-1+BCP-1, under the conditions same as those described in the above.

The dispersant polymers used herein are:

BCP-1: poly(lauryl methacrylate b-hexaethyleneoxyethylmethacrylate),

BCP-2: poly(lauryl methacrylate b-hexa(perfluoroethyleneoxy)ethyl methacrylate);

BCP-3: poly(lauryl methacrylate b-methacrylic acid); and

BCP-4: poly(3-hexyldecyl methacrylate b-3-ureidopropylmethacrylate).

Results are shown in Table 1-6.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 1-6.

TABLE 1-6

| | | Mean coefficient | | |
|---|---|---|---|---|
| | Discotic | of friction over 70 | Dispersant | |
| Example No. | polymer | to 100° C. | polymer | Sliding mark |
| 1-25 | DMP-6 | 0.07 | BCP-1 | ◯ |
| 1-26 | DMP-7 | 0.06 | BCP-2 | Δ |
| 1-27 | DMP-8 | 0.07 | BCP-1 | Δ |
| 1-28 | DMP-12 | 0.06 | BCP-1 | ◯ |
| 1-29 | DMP-19 | 0.05 | BCP-1 | Δ |
| 1-30 | DMP-22 | 0.04 | BCP-1 | ◯ |
| 1-31 | DMP-24 | 0.07 | BCP-2 | ◯ |
| 1-32 | DMP-27 | 0.06 | BCP-1 | Δ |
| 1-33 | DMP-28 | 0.04 | BCP-1 | Δ |
| 1-34 | DMP-29 | 0.065 | BCP-2 | ◯ |
| 1-35 | DMP-38 | 0.05 | BCP-2 | ◯ |
| 1-36 | DMP-39 | 0.055 | BCP-3 | ◯ |
| 1-37 | DMP-41 | 0.045 | BCP-4 | Δ |
| 1-38 | DMP-45 | 0.05 | BCP-3 | ◯ |
| 1-39 | DMP-47 | 0.06 | BCP-3 | Δ |
| 1-40 | DMP-48 | 0.035 | BCP-2 | ◯ |
| 1-41 | DMP-53 | 0.05 | BCP-2 | ◯ |
| 1-42 | DMP-57 | 0.07 | BCP-2 | Δ |
| Comparative | — | 0.136 | — | X |
| Example | | | | |
| 1-3 | | | | |
| Comparative | BCP-1 | 0.140 | — | X |
| Example | | | | |
| 1-14 | | | | |
| Comparative | BCP-1 + | 0.142 | — | X |
| Example | CP-1 | | | |
| 1-15 | | | | |

From the results shown in Table 1-6, it is understandable that the lubricant compositions, containing the discotic polymers as being micro-dispersed in the base oil rather than being dissolved therein, can distinctively decrease the coefficients of friction.

From the results shown in Table 1-6, it is also understandable that the lubricant compositions of the present invention containing the micro-dispersed discotic polymers show large anti-wearing property on the relative basis. In other words, the lubricant compositions containing the micro-dispersed discotic polymers may serve as desirable lubricating oils showing desirable levels of low friction property and anti-wearing property.

Similar test using the discotic polymers DMP-3 and 36 soluble to the base oil showed a mean coefficient of friction over 70 to 100° C. of 0.1 or around.

### 4. Evaluation of Function of Reducing Friction Depending on Methods of Dispersing Samples

### [Water-Base, Micro-Dispersion and Emulsion Dispersion Techniques]

### Examples 1-43 to 46 and Comparative Example 1-18

### Evaluation of Low Friction Property and Anti-Wearing Function of Discotic Polymer Micro-Dispersed into Water

The lubricant compositions were prepared by mixing 5 parts by mass of any of discotic polymers DMP-14, 37, 55 and 95 parts by mass of N-32. The mixture was added with 0.5 parts by mass of a block copolymer, and was then homogenized using an ultrasonic homogenizer, to thereby prepare the lubricant compositions having the discotic polymers stabilized therein while keeping a micro-dispersion state with a particle size of 0.5 μm.

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.9 μm in surface roughness, both of which being made of alumina.

On the disk, 120 mg of each of the above-described lubricant compositions was placed, load was applied to the cylinder, and the coefficient of friction over 40° C. to 110° C. was measured under the above-described conditions of reciprocative sliding.

The dispersant polymer used herein was:

BCP-3: poly(lauryl methacrylate b-methacrylic acid).

A detergent used herein for emulsification and dispersion was dodecylbenzene sulfonate (DBS).

Results are shown in Table 1-7.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 1-7.

TABLE 1-7

| | | Mean coefficient of | | |
|---|---|---|---|---|
| Example | Discotic | friction over 70 to | Dispersant | |
| No. | polymer | 100° C. | polymer | Sliding mark |
| 1-43 | DMP-14 | 0.04 | BCP-3 | ◯ |
| 1-44 | DMP-37 | 0.06 | BCP-3 | ◯ |
| 1-45 | DMP-37 | 0.06 | DBS | ◯ |
| 1-46 | DMP-55 | 0.05 | BCP-3 | ◯ |
| Comparative | — | 0.195 | BCP-3 | Δ |
| Example | | | | |
| 1-18 | | | | |

From the results shown in Table 1-7, it is understandable that the lubricant compositions, containing the discotic polymers as being micro-dispersed in water rather than being dissolved therein, can distinctively decrease the coefficients of friction.

From the results shown in Table 1-7, it is also understandable that the lubricant compositions containing the micro-dispersed discotic polymers show large anti-wearing property on the relative basis. In other words, the lubricant compositions containing the micro-dispersed discotic polymers in water may serve as desirable lubricating compositions showing desirable levels of low friction property and anti-wearing property, which are not kept unchanged on ceramics and on steel, and are therefore expected to be adoptable to a wide range of fields including lubricating fluid for artificial bone.

### [Dispersion Polymerization in Organic Solvent]

### Example 1-47

### Preparation of Micro-Dispersed Lubricant Composition by Dispersion Polymerization of Discotic Polymer DMP-32 in Base Oil

As shown below, DMP-39 was obtained by allowing the monomer of DMP-39 and 3,6-dioxyoctane-1,8-diol to react in a condensing manner in the base oil N-32. More specifically, 4.94 g of the DMP-39 monomer, 0.68 g of 3,6-dioxyoctane-1,8-diol, 0.5 g of tetrabutoxytitanium, and 0.1 g of poly(hexadecyl methacrylate b-methacrylic acid) were dissolved or dispersed in 100 g of Super Oil N-32 from Nippon Steel Chemical Co., Ltd., the mixture was allowed to react at 60° C. for 14 hours while removing the generated methanol under reduced pressure, to thereby obtain DMP-39 in a form of dispersed particle. The mean particle size of DMP-39 was found to be 0.46 μm.

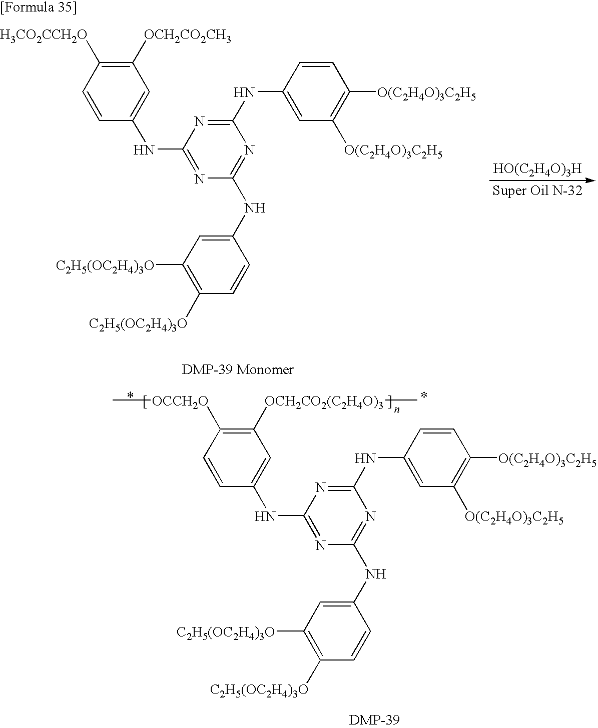

### Example 1-48

### Preparation of Micro-Dispersed Lubricant Composition by Dispersion Polymerization of Discotic Polymer DMP-7 in Base Oil

As shown below, DMP-7 was obtained by allowing the monomer of DMP-7 and 3,6-dioxyoctane-1,8-diol to react in a condensing manner in the base oil N-32.

More specifically, 4.94 g of the DMP-7 monomer, 0.68 g of 3,6-dioxyoctane-1,8-diol, and 0.1 g of poly(hexadecyl methacrylate b-methacrylic acid) were dissolved or dispersed in 100 g of Super Oil N-32 from Nippon Steel Chemical Co., Ltd., the mixture was heated at 40° C. for 10 hours under bubbling with dry nitrogen, while removing the generated hydrochloric acid under reduced pressure. The mixture was washed with 100 g of a 3% aqueous sodium bicarbonate solution and 100 g of water, to thereby obtain DMP-7 in a form of dispersed particle. The mean particle size of DMP-7 was found to be 0.23 μm.

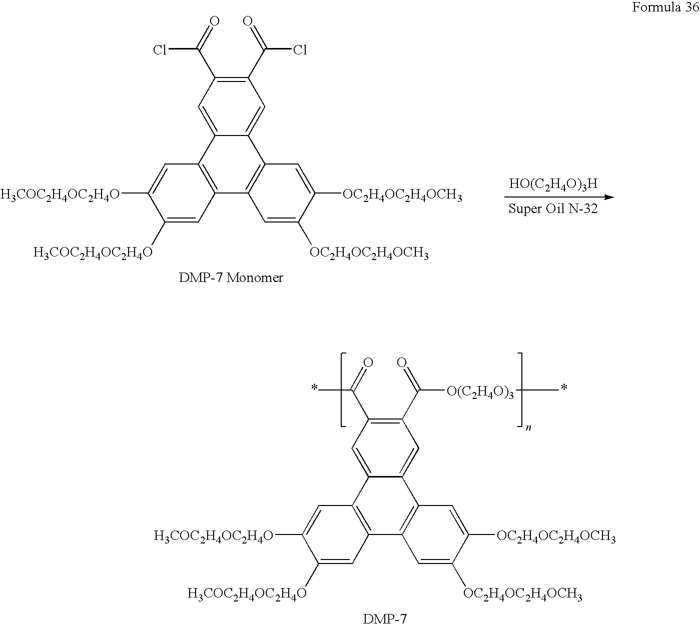

### Examples 1-49 and 50

### Evaluation of Low Friction Property and Anti-Wearing Function of Lubricant Composition Containing Discotic Polymers DMP-39 and DMP-7

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 0.65 μm in surface roughness, both of which being made of SUJ-2 steel.

On the disk, 120 mg of each of the above-described lubricant compositions was placed, load is applied to the cylinder, and the coefficient of friction over 40° C. to 110° C. was measured under the above-described conditions of reciprocative sliding.

Results are shown in Table 1-8.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 1-8.

TABLE 1-8

| | | Mean coefficient of | |
|---|---|---|---|
| | Discotic | friction over 70 to | |
| Example No. | polymer | 100° C. | Sliding mark |
| 1-49 | DMP-39 | 0.04 | ◯ |
| 1-50 | DMP-7 | 0.035 | ◯ |

From the results shown in Table 1-8, it is understandable that the lubricant compositions, containing the discotic polymers as being micro-dispersed therein, can distinctively decrease the coefficients of friction.

From the results shown in Table 1-8, it is also understandable that the lubricant compositions containing the micro-dispersed discotic polymers show a desirable level of anti-wearing property.

5. Evaluation of function of Reducing Friction by Thinning of Samples

### [Influences of Base and Surface Roughness]

### Examples 1-51 to 68

### Evaluation of Function of Reducing Friction of Discotic Polymer Film Coated on Substrate

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 0.65 μM in surface roughness. Materials composing the substrate are shown in Table 1-9.

On the disk, 3.0 mg of each discotic polymer was placed, dissolved with dichloromethane so as to uniformly spread it over the disk, to thereby obtain a film of approximately 6 μm thick. Load is applied to the cylinder, and the coefficient of friction over 40° C. to 110° C. was measured under the above-described conditions of reciprocative sliding.

Results are shown in Table 1-9.

TABLE 1-9

| | | Coefficient | Mean coefficient | |
|---|---|---|---|---|
| Example | Discotic | of friction | of friction over 70 | |
| No. | polymer | at 40° C. | to 100° C. | Substrate |
| 1-51 | DMP-9 | 0.13 | 0.04 | SUJ-2 |
| 1-52 | DMP-11 | 0.16 | 0.07 | SUJ-2 |
| 1-53 | DMP-16 | 0.16 | 0.05 | SUJ-2 |
| 1-54 | DMP-23 | 0.13 | 0.06 | SUJ-2 |
| 1-55 | DMP-27 | 0.05 | 0.025 | Carbon nitride |
| 1-56 | DMP-36 | 0.14 | 0.07 | Alumina |
| 1-57 | DMP-50 | 0.08 | 0.03 | Alumina |
| 1-58 | DMP-54 | 0.07 | 0.04 | SUJ-2 |
| 1-59 | DMP-55 | 0.23 | 0.08 | SUJ-2 |
| 1-60 | DMP-58 | 0.05 | 0.045 | SUJ-2 |
| 1-61 | DMP-7 | 0.05 | 0.01 | Polyacetal |
| 1-62 | DMP-12 | 0.06 | 0.015 | PEEK |
| 1-63 | DMP-19 | 0.055 | 0.025 | PPS |
| 1-64 | DMP-27 | 0.04 | 0.025 | Almina |
| 1-65 | DMP-38 | 0.13 | 0.05 | Polyimide |
| 1-66 | DMP-48 | 0.06 | 0.025 | Glass |
| 1-67 | DMP-53 | 0.055 | 0.05 | Silicon |
| 1-68 | DMP-57 | 0.065 | 0.04 | SUJ-2 |

From the results shown in Table 1-9, it is understandable that the coefficient of friction was distinctively reduced by forming the polymer (discotic polymer) film having the mesogen group on the surface of the sliding components. This effect was confirmed on any sliding components irrespective of the materials. Because more preferable low friction properties were observed for resin-made substrates having relatively small values of surface roughness, the discotic polymers are expected to be adoptable to a wide range of fields including lubrication film for resin-made sliding components, artificial bone, and so forth.

### 6. Solid Dispersion

### Example 1-69 and Comparative Example 1-19

### Dispersion of Discotic Polymer Particles into Binder

Under nitrogen gas flow and in a cup-like glass container, 20.0 g of ε-caprolactam was melted at 150° C. and kept under stirring, to which a mixture of 10.0 g of ε-caprolactam and 2.0 of DMP-54 preliminarily mixed and pulverized in a ball mill was added, and 0.51 mL of trilenediisocyanate was further added. On the other hand, another 20.0 g of ε-caprolactam was separately melted at 70° C., to which 0.10 g of NaH was added, and the resultant molten liquid was added to the above-described molten liquid containing DMP-54 and mixed. The stirring was stopped 2 minutes after, and the mixture was allowed to stand at 150° C. for 5 minutes, then cooled to room temperature, so as to obtain columnar 6,6-nylon resin having DMP-54 micro-particles dispersed therein.

As Comparative Example 1-19, a columnar 6,6-nylon resin was obtained by completely same operations except that DMP-54 was not added.

A 70 mm×50 mm×3 mm flat plate was formed by cutting each samples.

Sliding characteristics of the plates were then measured using a reciprocating sliding friction-and-wear tester (Model AFT-15MS, from Tosoku Seimitsu Kogyo, K.K., load=2 kg, linear velocity=30 mm/sec, reciprocating distance=20 mm, 23° C., number of times of reciprocating motion=30,000 times).

As for wearing characteristics, maximum depth of wear after 30,000 runs was measured using a surface roughness gauge (Surfcom 570-A-3D from Tokyo Seimitsu K.K.).

Results are shown in Table 1-10.

TABLE 1-10

| | | Coefficient of | |
|---|---|---|---|
| Example | | friction after | Depth of friction after |
| No. | Discotic polymer | 30,000 runs | 30,000 runs [μm] |
| 1-69 | DMP-54 | 0.21 | 58 |
| Comparative | — | 0.68 | 150 |
| Example | | | |
| 1-19 | | | |

From the results shown in Table 1-10, it is explicit that the resin containing DMP-54 were found to show more lower friction and higher anti-wearing property. It is supposed that a trace amount of discotic polymer residing on the surface formed a film in the process of sliding, and contributes to low friction, and to anti-wearing property as a consequence.

### 7. Lubricating Performance of Complex-Forming Compound

### Example 1-70

### Lubricating Performance of Complex-Forming Compounds of Discotic Polymer

According to the combinations shown in Table below, discotic polymer DMP-35 was mixed, in dichloromethane, with 0.5 molar equivalence on the mesogen basis of a complex-forming compound represented by the formula (4), or with a comparative compound (XA-1) shown in the Table below, the mixture was concentrated, heated at 120° C. for 30 minutes, air-cooled, and allowed to stand for 24 hours. On the disk, 3.0 mg of each sample was placed, dissolved with dichloromethane so as to uniformly spread it over the disk, to thereby obtain a film of approximately 6 μm thick. Load is applied to the cylinder, and the coefficient of friction over 40° C. to 110° C. was measured under reciprocative sliding according to conditions similar to those for Example 1-51. Coefficients of friction at 40° C. and presence/absence of sliding mark are shown in Table 1-11.

Next, viscosity index was evaluated under conditions similar to those for Example 1-2. Results are shown in Table 1-11.

TABLE 1-11

| | Complex- | Coefficient of | | |
|---|---|---|---|---|
| Discotic | forming | friction at | Viscosity | |
| polymer | compound | 40° C. | index | Sliding mark |
| DMP-35 | CP-1 | 0.09 | 169 | ◯ |
| DMP-35 | — | 0.21 | 162 | ◯ |
| DMP-35 | XA-1 | 0.17 | 162 | Δ to X |

[Formula 37]

| | |
|---|---|
| C₁₂H₂₅O(C₂H₄O)₄CH₂CO₂CH₃ | XA-1 |

From the results shown in Table 1-11, it is understandable that the coefficient of friction of DMP-35 at 40° C. is large in a film form, due to its relatively high viscosity, but decreases distinctively when added with the complex-forming compounds. This is supposedly because the polymer lowers its viscosity by forming the complex, and develops a distinct effect of reducing friction. On the other hand, the composition using XA-1 having no complex-forming ability despite its closely resembled structure reduced the coefficient of friction to a certain degree by virtue of its dilution effect, but also lowered strength of film due to its solvent effect, to thereby degrade the anti-wearing property. In addition, viscosity index was improved supposedly because the complex formation further enhanced the viscosity increasing effect. As described in the above, the complex formation was found to effectively function on the lubricating performance.

### Example 2-1

### Preparation of Polymer Having Mesogen Structure (Including Discotic Structure) in Side Chains

Methods of synthesizing triphenylene rings (Exemplary Compounds DSP-1 to 13) as general examples of the mesogen structure are detailed in Liquid Crystals., Vol. 31, No. 8, p. 1037 (2004) and references cited therein, and have a wide variation depending on the bonding mode of the side-chain polymers.

For example, Exemplary Compounds DSP-1 to 18, DSP-26 to 42, DSP-49 to 55 were synthesized by combining the mesogen rings according to the method described in J. Mater. Chem., Vol. 8, No. 1, p. 47 (1998).

Exemplary Compounds DSP-19 to 25, DSP-47, 48, DSP-56 and 57 were synthesized by combining the mesogen rings according to the method described in Makromol. Chem. Rapid Commun., Vol. 14, p. 329 (1993).

Exemplary Compound DSP-43 to 46, and DSP-58 were synthesized by combining the mesogen rings according to the method described in Macromolecules, Vol. 29, p. 6143 (1997).

Hexa-substituted benzene ring (Exemplary Compound DSP-55) was synthesized according to the method described in Makromol. Chem. Rapid Commun., Vol. 6, p. 367 (1985). Tri-substituted benzene rings (Exemplary Compounds DSP-56 and 57) were synthesized according to the method described in Liquid Crystals., Vol. 26, No. 10, p. 1501 (1999).

Triaryl melamine rings (Exemplary Compounds DSP-31 to 48) were synthesized according to the method described in Liquid Crystals., Vol. 24, No. 3, p. 407 (1998).

Hexaethynylbenzene rings (Exemplary Compounds DSP-49 to 51) were synthesized according to the method described in Angew. Chem. Int. Ed., Vol. 39, No. 17, p. 3140 (2000).

Phthalocyanine rings (Exemplary Compounds DSP-52 to 54) were synthesized according to the method described in Japanese Laid-Open Patent Publication No. 2000-119652.

### 1. Evaluation of Function of Improving Viscosity Index of Highly-Soluble Discotic Polymer

### Examples 2-2 to 23, Comparative Examples 2-1 to 3, Referential Examples 1 and 2

### Preparation of Lubricant Composition and Evaluation of Effect of Improving Viscosity Index of Highly-Soluble Discotic Polymer

Five parts by mass of the polymers (discotic polymers) having the mesogen structures obtained in Example 2-1 and 95 parts by mass of Super Oil N-32 (from Nippon Steel Chemical Co., Ltd.) as the base oil for lubricating oil were heated to 100° C. under microscopes (microscopic heating device FP-80HT Hot Stage from Mettler Inc., and OPTIPHOT-POL from Nikon Corporation) at a 400× magnification, and 15 parts by mass of those confirmed as being completely dissolved at 100° C. (DSP-3, 10, 15, 26, 30, 35, 44, 51, 52, 55, 56, 59, 6, 61, 62, 63, 64, 65, 66, 67, 68), and those showing almost no changes in the state of dispersion of micro-solid even heated to 100° C. (DSP-8, 39) were mixed with 85 parts by mass of N-32, to thereby prepare lubricant compositions.

As Comparative Examples, lubricant compositions were prepared according to a similar method, respectively using a polymethacrylate-base viscosity index improver (CP-1) and a viscosity index improver (CP-2) composed of an ethylene-maleic anhydride grafted amine modified product.

Thus prepared lubricating oils were evaluated as follows.

### (Function of Improving Viscosity Index)

Dynamic viscosity (at 100° C. and 40° C.) of the lubricating oils of Examples 2-2 to 23, Comparative Examples 2-1 to 3, and Referential Examples 1 and 2 were measured using an Ubbelohde viscometer, and viscosity indices were calculated conforming to JIS K2283. Viscosity of Super Oil N-32 (from Nippon Steel Chemical Co., Ltd.) used for preparing the lubricant composition (that is, lubricating oil before being added with the discotic polymers) was found to be 30.6 mm²/s at 40° C., and 5.31 mm²/s at 100° C., and viscosity index was found to be 106.

### (Shearing Stability (Rate of Decrease in Viscosity))

Conforming to JASO Standards M347-95 issued by Society of Automotive Engineers of Japan, the lubricant compositions of Examples 2-2 to 23, Comparative Examples 2-1 to 3, and Referential Examples 1 and 2 were irradiated with ultrasonic wave at 100° C. for a specified duration of time. The viscosity after the irradiation was measured, and rate of decrease in viscosity of the lubricant compositions was measured based on the viscosity values obtained before and after the irradiation. Smaller rate of decrease in viscosity of the lubricant composition means larger shearing stability of the viscosity index improver.

TABLE 2-1

| | | | | | Rate of |
|---|---|---|---|---|---|
| | Material | Dynamic | Dynamic | | decrease in |
| | added | viscosity at | viscosity at | Vis- | dynamic |
| Example | to | 40° C. | 100° C. | cosity | viscosity at |
| No. | N-32 | [mm²/s] | [mm²/s] | index | 100° C. [%] |
| 2-2 | DSP-3 | 97.0 | 15.4 | 172 | 0.4 |
| 2-3 | DSP-10 | 87.1 | 14.1 | 166 | 0.6 |
| 2-4 | DSP-15 | 87.1 | 14.1 | 166 | 0.6 |
| 2-5 | DSP-26 | 52.0 | 8.87 | 149 | 0.4 |
| 2-6 | DSP-30 | 94.1 | 14.7 | 163 | 0.4 |
| 2-7 | DSP-31 | 52.3 | 8.89 | 150 | 0.6 |
| 2-8 | DSP-35 | 59.3 | 10.0 | 160 | 0.5 |
| 2-9 | DSP-44 | 77.6 | 12.3 | 161 | 0.5 |
| 2-10 | DSP-51 | 66.5 | 11.4 | 165 | 0.4 |
| 2-11 | DSP-52 | 93.1 | 14.4 | 163 | 0.7 |
| 2-12 | DSP-55 | 78.0 | 12.1 | 150 | 0.4 |
| 2-13 | DSP-56 | 95.6 | 14.7 | 161 | 0.4 |
| 2-14 | DSP-59 | 77.4 | 12.1 | 155 | 0.5 |
| 2-15 | DSP-60 | 66.1 | 10.8 | 153 | 0.6 |
| 2-16 | DSP-61 | 80.3 | 12.5 | 156 | 0.4 |
| 2-17 | DSP-62 | 80.9 | 12.2 | 150 | 0.5 |
| 2-18 | DSP-63 | 76.8 | 11.6 | 144 | 0.4 |
| 2-19 | DSP-64 | 76.8 | 12.6 | 165 | 0.4 |
| 2-20 | DSP-65 | 73.6 | 11.1 | 143 | 0.6 |
| 2-21 | DSP-66 | 75.8 | 12.1 | 159 | 0.5 |
| 2-22 | DSP-67 | 81.4 | 12.8 | 157 | 0.5 |
| 2-23 | DSP-68 | 89.9 | 13.1 | 149 | 0.4 |
| Comparative | — | 30.6 | 5.31 | 106 | — |
| Example | | | | | |
| 2-1 | | | | | |
| Comparative | CP-1 | 100.2 | 14.2 | 145 | 0.8 |
| Example | | | | | |
| 2-2 | | | | | |
| Comparative | CP-2 | 101 | 15.5 | 162 | 1.2 |
| Example | | | | | |
| 2-3 | | | | | |
| Referential | DSP-8 | 72.1 | 9.8 | 113 | — |
| Example | | | | | |
| 2-1 | | | | | |
| Referential | DSP-39 | 108 | 12.5 | 108 | — |
| Example | | | | | |
| 2-2 | | | | | |

From the results shown in Table 2-1, it is understandable that, of the discotic polymers having the mesogen structure in the main chains thereof, those having large solubility at 100° C. (Examples 2-2 to 23) generally show high viscosity indices equivalent to those of general viscosity index improvers, whereas those having poor solubility (Referential Examples 1 and 2) show the values not so different from the viscosity index of the base oil itself. In short, the results suggest that the function of viscosity index improver making use of temperature-dependent difference between solubility and insolubility of polymer may be developed through a similar mechanism, also by the lubricant compositions containing the discotic polymers.

Also as for shearing stability, it is understandable that the discotic polymers show small rate of decrease in viscosity index, and have desirable properties as a viscosity index improver.

### 2. Evaluation of Various Performances Relating to Function of Improving Viscosity Indices of Highly-Soluble Samples

### Examples 2-24 to 27, Comparative Examples 2-6 and 7

### Evaluation of Various Performances Relating to Function of Improving Viscosity Indices of Highly-Soluble Samples

Fifteen parts by mass of discotic polymers DSP-26, DSP-44, and CP-1, CP-2 for comparison, and 85 parts by mass of N-32 were respectively mixed to thereby prepare the lubricant compositions.

Various performances relating to performance of improving viscosity indices were evaluated similarly to as in Example in the above. Results are shown in Table 2-2 and Table 2-3.

### (Viscosity Properties at Low Temperatures)

MRV (mini-rotary viscometer), CCS (cold-cranking simulator) and TP-1 of thus prepared lubricant compositions were respectively measured. Results are shown in Table 2-2. The MRV, CCS and TP-1 are values expressing viscosity properties of composition at low temperatures.

MRV (mini-rotary viscometer) is measured according to a method described in ASTM-D3829, wherein viscosity is measured on the centipoise basis. Measurement temperature is −25° C.

CCS (cold-cranking simulator) is measured according to the method described in SAE J300 Appendix, wherein viscosity values under high shearing is measured on the centipoise basis. The test relates to resistivity of lubricating oil against cold-start of engine. The higher the CCS becomes, the larger the resistivity of oil against cold-start of engine becomes.

TP-1 is measured according to the method described in ASTM-D4684. This is substantially equivalent to MRV, except that gradual cooling cycle is adopted. The cycle is specified by SAE Paper No. 85 0443 (K. O. Henderson).

### (Sludge Dispersion)

Sludge dispersibility of thus prepared lubricating oils was tested. Criteria for judgment are shown below:

∘ . . . no sedimentation of sludge observed;

Δ . . . slight sedimentation of sludge observer; and

x . . . sedimentation of sludge observed.

Results of the test are shown in Table 2-2.

TABLE 2-3

| | | Viscosity property | | | |
|---|---|---|---|---|---|
| | Viscosity | at low temperatures | | | |
| Example | index | MRV | CCS | TP-1 | Sludge |
| No. | improver | (cP) | (cP) | (cP) | dispersibility |
| 2-24 | DSP-26 | 11,685 | 2,573 | 11,869 | ∘ |
| 2-25 | DSP-44 | 12,180 | 2,250 | 11,345 | ∘ |
| 2-26 | DSP-59 | 11,005 | 2,442 | 10,003 | ∘ |
| 2-27 | DSP-60 | 12,752 | 2,705 | 10,520 | ∘ |
| 2-6 | CP-1 | 13,394 | 2,887 | 12,309 | x |
| Comparative | CP-2 | 16,688 | 3,514 | 14,248 | Δ |
| Example | | | | | |
| 2-7 | | | | | |

It is understandable from the results shown in Table 2-2 that the lubricant compositions of Examples 2-24 to 27 are superior to the lubricant compositions of Comparative Examples 2-6 and 7, in all viscosity properties at low temperatures in terms of MRV, CCS and TP-1.

It is also understandable that, in terms of sludge dispersibility, the lubricant compositions of Examples 2-24 to 27 are superior to the lubricant compositions of Comparative Examples 2-6 and 7.

### Examples 2-28 to 31, Comparative Examples 2-8 and 9

### Preparation and Evaluation of Lubricant Compositions

### (Method of Testing Anti-Oxidative Property)

Ten parts by mass each of DSP-26, 44, 59 and 60 were homogenously dissolved into 90 parts by mass of 100-neutral mineral oil to thereby prepare the lubricant compositions. Also the lubricant compositions shown in the Table below were prepared respectively using CP-1 and CP-2, according to the same method.

Thus prepared lubricant compositions were subjected to anti-oxidative test at 165.5° C. for 98 hours conforming to JIS-K2514, and the amount of production of sludge was measured by the B method. The B method herein refers to a method measuring the amount of sludge precipitated by centrifugation from the tested lubricating oils added with a sludge flocculant, wherein the amount of sludge determined by the B method indicates the anti-oxidant property.

### (Carbon Black Dispersibility Test)

In a sample container for anti-emulsification property test (JISK2839), 0.3 g of carbon black was placed, and each of solutions obtained by respectively adding 3% by weight each of DSP-26 and DSP-44 synthesized in Example 2-1, and the additives (CP-1) and (CP-2) used in Comparative Examples 2-6 and 7 to 60-neutral mineral oil, was added so as to adjust the total volume to 80 ml. Each mixture was stirred using an anti-emulsification tester (JISK2520) at 30° C., 1,500 rpm for 5 minutes, 75 ml of the mixture was then transferred to a 100-ml centrifugal tube, centrifuged at 2,000 rpm for 20 minutes, the supernatant was diluted by a factor of 60 with the 60-neutral mineral oil, and absorbance at a wavelength of 750 nm was measured. Larger absorbance means better dispersibility, and indicates smaller amount of sludge produced by oxidation, and correlates with cleaning-dispersing performance. Results are shown in Table 2-3.

TABLE 2-3

| | | Viscosity at | | |
|---|---|---|---|---|
| Example | Viscosity index | −40° C. | Amount of | |
| No. | improver | (cSt) | sludge (%) | Absorbance |
| 2-28 | DSP-26 | 41,200 | 1.2 | 0.55 |
| 2-29 | DSP-44 | 38,100 | 1.5 | 0.71 |
| 2-30 | DSP-59 | 39,000 | 1.2 | 0.70 |
| 2-31 | DSP-60 | 41,000 | 1.0 | 0.66 |
| Comparative | CP-1 | 47,000 | 2.5 | 0.23 |
| Example | | | | |
| 2-8 | | | | |
| Comparative | CP-2 | 44,000 | 1.6 | 0.15 |
| Example | | | | |
| 2-9 | | | | |

From the results shown in Table 2-3, it is understandable that DSP-26, 44, 59 and 60 are far better in dispersibility as compared with the conventional viscosity index improvers CP-1 and CP-2, in other words, excellent in the anti-oxidative property and cleaning-dispersing performance.

The polymer having the mesogen group in the side chains thereof has low-temperature viscosity characteristics and anti-oxidative characteristics better than those of methacrylic-polymer-base viscosity index improver having been used conventionally as the viscosity index improver. The lubricant compositions of the present invention containing such polymer are, therefore, excellent in the fluidity characteristics at low temperatures and anti-oxidative stability at high temperatures, and may be used even under severe environment.

### Examples 2-32 to 35, Comparative Examples 2-10 and 11

### Preparation and Evaluation of Lubricant Compositions (Traction Coefficient)

The lubricant compositions were respectively prepared by blending 8.3% each of DSP-26 and DSP-44, 11% of engine oil package (for SH standard oil) and 80.7% of general 100-neutral mineral oil, and viscosity at 100° C. necessarily be taken into consideration for engine oil was adjusted to 10.0 to 10.4 cSt. As Comparative Examples, the lubricant compositions were respectively prepared by blending 4.3% each of the viscosity index improver CP-1, and 1% or none of molybdenum thiocarbamate-base FM agent (Molyvan A, from Vanderbilt Co., Inc.), with which 11% of engine oil package (SH standard oil) and general 100-neutral mineral oil were blended, and viscosity at 100° C. necessarily be taken into consideration for engine oil was respectively adjusted to 10.0 to 10.4 cSt, to thereby prepare the lubricant compositions. Coefficients of friction of these samples were measured using SRV friction-and-wear tester under conditions including a temperature of 80° C., a load of 50 N, and a frequency of 50 Hz, and results shown in Table 2-4 were obtained.

### [Table 15]

TABLE 2-4

| Example | | | |
|---|---|---|---|
| No. | | FM Agent | Traction coefficient |
| 2-32 | DSP-26 | not added | 0.121 |
| 2-33 | DSP-44 | not added | 0.135 |
| 2-34 | DSP-59 | not added | 0.115 |
| 2-35 | DSP-60 | not added | 0.096 |
| Comparative | CP-1 | not added | 0.159 |
| Example | | | |
| 2-10 | | | |
| Comparative | CP-1 | added | 0.055 |
| Example | | | |
| 2-11 | | | |

### Examples 2-36 to 39 and Comparative Examples 2-12

### Preparation and Evaluation of Lubricant Compositions

An OCP-base viscosity index improver (Orpheus M-1210, from Mitsui Petro-Chemical Industry Co.) composed of ethylene-propylene copolymer was used under the name of CP-3.

Five percent each of the discotic polymers DSP-26, DSP-44, and viscosity index improver CP-3, and 5% of DI package for CD-grade Diesel engine oil were added to solvent-refined oil A (150-neutral oil with a viscosity index of 100) and solvent-refined oil B (200-neutral oil with a viscosity index of 100), to thereby prepare engine oils (lubricant compositions) corresponded to Examples and Comparative Example shown in Table 2-5 below. In this case, amounts of mixing of the solvent-refined oils A and B were adjusted so as to make dynamic viscosity at 100° C. fall in the range from 10.0 to 10.4 cSt, and so as to adjust CCS viscosity at −20° C. to 3,000 cP. These engine oils were subjected to panel coking test and anti-oxidative stability test. Results are shown in Table 2-5. TBS viscosity (150° C., at a shearing speed of 10⁶/sec) and viscosity index relevant to fuel saving property were shown in Table 2-5.

### (Method of Panel Coking Test)

Three types of engine oils described in the above were subjected to panel coking test conforming to the method of panel coking test Fed-791B, at a panel temperature of 300° C., a temperature of engine oil of 100° C. for 4 hours. After the test, the panels were cleaned with pentane, and the amount of coking was measured by a gravimetric method.

### (Method of Anti-Oxidative Stability Test)

Three types of the above-described engine oils were subjected to the anti-oxidative stability test conforming to JIS-K2514, at 165.5° C. for 96 hours. The amount of increase in the total acid based on the values before and after the test was measured.

TABLE 2-5

| | | | Anti-oxidative | | |
|---|---|---|---|---|---|
| | | | stability based | | |
| | | | on amount of | | |
| | | | increase in | | |
| | Viscosity | Amount of | total acid | TBS | Vis- |
| Example | index | coking | value | viscosity | cosity |
| No. | improver | [mg] | [mgKOH/g] | [mPa · s] | index |
| 2-36 | DSP-26 | 49 | 1.6 | 2.58 | 165 |
| 2-37 | DSP-44 | 51 | 1.9 | 2.91 | 158 |
| 2-38 | DSP-59 | 58 | 1.6 | 2.86 | 162 |
| 2-39 | DSP-60 | 52 | 1.8 | 2.99 | 152 |
| Comparative | CP-1 | 83 | 2.8 | 3.15 | 150 |
| Example | | | | | |
| 2-12 | | | | | |

From the results shown in Table 2-5, it is understandable that the engine oils using the polymers having the mesogen groups show smaller amounts of coking as compared with those shown by the OCP-base viscosity index improvers, considered as producing only small amounts of coking (Comparative Example 2-12). It is also understandable that these oils are low in the TBS viscosity, and have equivalent or larger viscosity indices.

### 3. Functional Evaluation of Low Friction Property of Sample Less Soluble to Base Oil

### Examples 2-40 to 57 and Comparative Examples 2-13 to 16

### Low Friction Property and Anti-Wearing Function of Discotic Polymer Micro-Dispersed in Base Oil

Five parts by mass of the discotic polymers obtained in Example 2-1 and 95 parts by mass of Super Oil N-32 (from Nippon Steel Chemical Co., Ltd.) as the base oil for lubricating oil were heated to 100° C. under microscopes (microscopic heating device FP-80HT Hot Stage from Mettler Inc., and OPTIPHOT-POL from Nikon Corporation) at a 400× magnification, and 5 parts by mass of the compounds less soluble to the base oil, showing almost no changes in the state of dispersion of micro-solid matters between 40° C. and 100° C. (DSP-6, 7, 8, 12, 21, 22, 24, 27, 28, 29, 38, 41, 45, 47, 48, 53, 57) were mixed with 95 parts by mass of N-32, to thereby prepare lubricant compositions. The lubricant compositions were further added with 0.5 parts by mass of a block copolymer, and was then homogenized using an ultrasonic homogenizer, to thereby prepare the lubricant compositions having the discotic polymers stabilized therein while keeping a micro-dispersion state with a particle size of 0.5 μm.

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 65 μm in surface roughness, both of which being made of SUJ-2 steel.

On the disk, 120 mg of each of the above-described lubricant compositions was placed, the load was applied to the cylinder, and the coefficient of friction over 40° C. to 110° C. was measured under the above-described conditions of reciprocative sliding.

For comparison, coefficients of friction were measured also for N-32 base oil, N-32 base oil+BCP-1, and N-32 base oil+CP-1+BCP-1, under the conditions same as those described in the above.

The dispersant polymers used herein are:

BCP-1: poly(lauryl methacrylate b-hexaethyleneoxyethylmethacrylate),

BCP-2: poly(lauryl methacrylate b-hexa(perfluoroethyleneoxy)ethyl methacrylate);

BCP-3: poly(lauryl methacrylate b-methacrylic acid), and

BCP-4: poly(3-hexyldecylmethacrylate b-3-ureidopropylmethacrylate).

Results are shown in Table 2-6.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 2-6.

TABLE 2-6

| | | Mean coefficient | | |
|---|---|---|---|---|
| | Discotic | of friction over | Dispersant | |
| Example No. | polymer | 70 to 100° C. | polymer | Sliding mark |
| 2-40 | DSP-6 | 0.07 | BCP-1 | ◯ |
| 2-41 | DSP-7 | 0.08 | BCP-2 | ◯ |
| 2-42 | DSP-8 | 0.07 | BCP-1 | ◯ |
| 2-43 | DSP-12 | 0.07 | BCP-1 | ◯ |
| 2-44 | DSP-21 | 0.07 | BCP-1 | Δ |
| 2-45 | DSP-22 | 0.05 | BCP-1 | ◯ |
| 2-46 | DSP-24 | 0.06 | BCP-2 | ◯ |
| 2-47 | DSP-27 | 0.05 | BCP-1 | ◯ |
| 2-48 | DSP-28 | 0.05 | BCP-1 | Δ |
| 2-49 | DSP-29 | 0.05 | BCP-2 | ◯ |
| 2-50 | DSP-38 | 0.07 | BCP-2 | Δ |
| 2-51 | DSP-39 | 0.06 | BCP-3 | ◯ |
| 2-52 | DSP-41 | 0.045 | BCP-4 | ◯ |
| 2-53 | DSP-45 | 0.06 | BCP-3 | Δ |
| 2-54 | DSP-47 | 0.064 | BCP-3 | Δ |
| 2-55 | DSP-48 | 0.04 | BCP-2 | ◯ |
| 2-56 | DSP-53 | 0.06 | BCP-2 | Δ |
| 2-57 | DSP-57 | 0.08 | BCP-2 | Δ |
| Comparative | — | 0.136 | — | X |
| Example 2-13 | | | | |
| Comparative | BCP-1 | 0.140 | — | X |
| Example | | | | |
| 2-14 | | | | |
| Comparative | BCP-1 + | 0.142 | — | X |
| Example | CP-1 | | | |
| 2-15 | | | | |

From the results shown in Table 2-6, it is understandable that the lubricant compositions, containing the discotic polymers as being micro-dispersed in the base oil rather than being dissolved therein, can distinctively decrease the coefficients of friction.

From the results shown in Table 2-6, it is also understandable that the lubricant compositions containing the micro-dispersed discotic polymers show large anti-wearing property on the relative basis. In other words, the lubricant compositions containing the micro-dispersed discotic polymers may serve as desirable lubricating oils showing desirable levels of low friction property and anti-wearing property.

Similar test using the discotic polymers DSP-3 and 36 soluble to the base oil showed a mean coefficient of friction over 70 to 100° C. of 0.12 to 0.13 or around.

### 4. Evaluation of Function of Reducing Friction Depending on Methods of Dispersing

### [Water-Base, Micro-Dispersion and Emulsion Dispersion Techniques]

### Examples 2-58 to 61 and Comparative Example 2-18

### Evaluation of Low Friction Property and Anti-Wearing Function of Discotic Polymer Micro-Dispersed into Water

The lubricant compositions were prepared by mixing 5 parts by mass of any of discotic polymers DSP-14, 37, 55 and 95 parts by mass of N-32. The mixture was added with 0.5 parts by mass of a block copolymer, and was then homogenized using an ultrasonic homogenizer, to thereby prepare the lubricant compositions having the discotic polymers stabilized therein while keeping a micro-dispersion state with a particle size of 0.5 μm.

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.9 μm in surface roughness, both of which being made of alumina.

On the disk, 120 mg of each of the above-described lubricant compositions was placed, load was applied to the cylinder, and the coefficient of friction over 40° C. to 110° C. was measured under the above-described conditions of reciprocative sliding.

The dispersant polymer used herein was:

BCP-3: poly(lauryl methacrylate b-methacrylic acid).

A detergent used herein for emulsification and dispersion was dodecylbenzene sulfonate (DBS).

Results are shown in Table 2-7.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 2-7.

TABLE 2-7

| | | Mean coefficient | | |
|---|---|---|---|---|
| Example | Discotic | of friction over 70 | Dispersant | |
| No. | polymer | to 100° C. | polymer | Sliding mark |
| 2-58 | DSP-14 | 0.06 | BCP-3 | ◯ |
| 2-59 | DSP-37 | 0.07 | BCP-3 | ◯ |
| 2-60 | DSP-37 | 0.07 | DBS | Δ |
| 2-61 | DSP-55 | 0.06 | BCP-3 | ◯ |
| Comparative | — | 0.195 | BCP-3 | Δ |
| Example | | | | |
| 2-18 | | | | |

From the results shown in Table 2-7, it is understandable that the lubricant compositions, containing the discotic polymers as being micro-dispersed in water rather than being dissolved therein, can distinctively decrease the coefficients of friction.

From the results shown in Table 2-7, it is also understandable that the lubricant compositions containing the micro-dispersed discotic polymers show large anti-wearing property on the relative basis. In other words, the lubricant compositions containing the micro-dispersed discotic polymers in water may serve as desirable lubricating compositions showing desirable levels of low friction property and anti-wearing property, which are not kept unchanged on ceramics and on steel, and are therefore expected to be adoptable to a wide range of fields including lubricating fluid for artificial bone.

### [Dispersion Polymerization in Organic Solvent]

### Example 2-62

### Preparation of Micro-Dispersed Lubricant Composition by Dispersion Polymerization of Discotic Polymer DSP-32 in Base Oil

DSP-39 was obtained by allowing radical addition polymerization of DSP-39 monomer to proceed in the base oil N-32. More specifically, 5.23 g of DSP-39 monomer, 0.2 g of AIBN, and 0.1 g of poly(hexadecyl methacrylate b-methacrylic acid) were dissolved or dispersed in 100 g of Super Oil N-32 from Nippon Steel Chemical Co., Ltd. and 15 g of 2-butanone, the mixture was heated to 60° C. for 10 hours, 2-butanone was then removed under reduced pressure, to thereby obtain DSP-39 in a form of dispersed particle. The mean particle size of DSP-39 was found to be 0.88 μm.

### Example 2-63

### Preparation of Micro-Dispersed Lubricant Composition by Dispersion Polymerization of Discotic Polymer DSP-7 in Base Oil

DSP-7 was obtained by radical addition polymerization in the base oil N-32, similarly to DSP-39 described in the above, in a form of dispersed particles. The mean particle size of DSP-7 was found to be 0.77 μm.

### Examples 2-64 and 65

### Evaluation of Low Friction Property and Anti-Wearing Function of Lubricant Composition Containing Discotic Polymers DSP-39 and DSP-7

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 0.65 μm in surface roughness, both of which being made of SUJ-2 steel.

On the disk, 120 mg of each of the above-described lubricant compositions was placed, load is applied to the cylinder, and the coefficient of friction over 40° C. to 110° C. was measured under the above-described conditions of reciprocative sliding.

Results are shown in Table 2-8.

States of wearing on the surface of the disk after the friction-and-wear test were evaluated according to 3-step criteria below:

∘ . . . sliding mark not observed;
Δ . . . sliding mark observed without wearing; and
x . . . sliding mark and wearing mark clearly observed.

Also these results are shown in Table 2-8.

TABLE 2-8

| | | Mean coefficient | |
|---|---|---|---|
| | Discotic | of friction over 70 | |
| Example No. | polymer | to 100° C. | Sliding mark |
| 2-64 | DSP-39 | 0.055 | ◯ |
| 2-65 | DSP-7 | 0.04 | ◯ |

From the results shown in Table 2-8, it is understandable that the lubricant compositions, containing the discotic polymers as being micro-dispersed therein, can distinctively decrease the coefficients of friction.

From the results shown in Table 2-8, it is also understandable that the lubricant compositions containing the micro-dispersed discotic polymers show a desirable level of anti-wearing property.

5. Evaluation of function of Reducing Friction by Thinning of Samples

### [Influences of Substrate and Surface Roughness]

### [2-66 to 83: Evaluation of Function of Reducing Friction of Discotic Polymer Film Coated on Substrate]

Using a reciprocating sliding friction-and-wear tester (SRV) from Optimol Instruments, and based on the cylinder-on-disk method, coefficients of friction were measured under conditions including a frequency of 50 Hz, an amplitude of 1.5 mm, and a load of 400 N. The cylinder was 15 mm in diameter and 22 mm in length, and the disk was 25 mm in diameter, 6.9 mm in thickness, and 0.45 to 0.65 μm in surface roughness. Materials composing the substrate are shown in Table 2-9.

On the disk, 3.0 mg of each discotic polymer was placed, dissolved with dichloromethane so as to uniformly spread it over the disk, to thereby obtain a film of approximately 6 μm thick. Load is applied to the cylinder, and the coefficient of friction over 40° C. to 110° C. was measured under the above-described conditions of reciprocative sliding.

Results are shown in Table 2-9.

TABLE 2-9

| | | | Mean | |
|---|---|---|---|---|
| | | | coefficient of | |
| Example | Discotic | Coefficient of | friction over 70 | |
| No. | polymer | friction at 40° C. | to 100° C. | Substrate |
| 2-66 | DSP-9 | 0.14 | 0.04 | SUJ-2 |
| 2-67 | DSP-11 | 0.17 | 0.06 | SUJ-2 |
| 2-68 | DSP-16 | 0.15 | 0.06 | SUJ-2 |
| 2-69 | DSP-23 | 0.12 | 0.06 | SUJ-2 |
| 2-70 | DSP-27 | 0.05 | 0.03 | Carbon nitride |
| 2-71 | DSP-36 | 0.15 | 0.06 | Alumina |
| 2-72 | DSP-50 | 0.09 | 0.05 | Alumina |
| 2-73 | DSP-53 | 0.06 | 0.04 | SUJ-2 |
| 2-74 | DSP-55 | 0.21 | 0.05 | SUJ-2 |
| 2-75 | DSP-58 | 0.06 | 0.055 | SUJ-2 |
| 2-76 | DSP-7 | 0.05 | 0.02 | Polyacetal |
| 2-77 | DSP-12 | 0.08 | 0.015 | PEEK |
| 2-78 | DSP-19 | 0.16 | 0.06 | PPS |
| 2-79 | DSP-27 | 0.05 | 0.03 | Alumina |
| 2-80 | DSP-38 | 0.11 | 0.04 | Polyimide |
| 2-81 | DSP-48 | 0.05 | 0.02 | Glass |
| 2-82 | DSP-53 | 0.045 | 0.02 | Silicon |
| 2-83 | DSP-57 | 0.055 | 0.05 | SUJ-2 |

From the results shown in Table 2-9, it was found that the discotic polymer of the present invention in a film form can distinctively reduce coefficient of friction of the conventional sliding components irrespective of the materials thereof. Because more preferable low friction properties were observed for resin-made substrates having relatively small values of surface roughness, the discotic polymers are expected to be adoptable to a wide range of fields including lubrication film for resin-made sliding components, artificial bone, and so forth.

### 6. Solid Dispersion

### Example 2-84 and Comparative Example 2-19

### Dispersion of Discotic Polymer Particles into Binder

Under nitrogen gas flow and in a cup-like glass container, 20.0 g of ε-caprolactam was melted at 150° C. and kept under stirring, to which a mixture of 10.0 g of ε-caprolactam and 2.0 of DSP-54 preliminarily mixed and pulverized in a ball mill was added, and 0.51 mL of trilenediisocyanate was further added. On the other hand, another 20.0 g of ε-caprolactam was separately melted at 70° C., to which 0.10 g of NaH was added, and the resultant molten liquid was added to the above-described molten liquid containing DSP-54 and mixed. The stirring was stopped 2 minutes after, and the mixture was allowed to stand at 150° C. for 5 minutes, then cooled to room temperature, so as to obtain a columnar 6,6-nylon resin having DSP-54 micro-particles dispersed therein.

As Comparative Example 2-19, a columnar 6,6-nylon resin was obtained by completely same operations except that DSP-54 was not added.

A 70 mm×50 mm×3 mm flat plate was formed by cutting each samples.

Sliding characteristics of the plates were then measured using a reciprocating sliding friction-and-wear tester (Model AFT-15MS, from Tosoku Seimitsu Kogyo, K.K., load=2 kg, linear velocity=30 mm/sec, reciprocating distance=20 mm, 23° C., number of times of reciprocating motion=30,000 times).

As for wearing characteristics, maximum depth of wear after 30,000 runs was measured using a surface roughness gauge (Surfcom 570-A-3D from Tokyo Seimitsu K.K.).

Results are shown in Table 2-10.

TABLE 2-10

| | | | Depth of |
|---|---|---|---|
| | | Coefficient of | friction after |
| Example | Discotic | friction after | 30,000 runs |
| No. | polymer | 30,000 runs | [μm] |
| 2-84 | DSP-54 | 0.33 | 52 |
| Comparative | — | 0.68 | 150 |
| Example | | | |
| 2-19 | | | |

As is understood from the results shown in Table 2-10, the resin containing DSP-54 were found to show more lower friction and higher anti-wearing property. It is supposed that a trace amount of discotic polymer residing on the surface formed a film in the process of sliding, and contributes to low friction, and to anti-wearing property as a consequence.

### 7. Lubricating Performance of Complex-Forming Compounds

### Example 2-85

### Lubricating Performance of Complex-Forming Compounds of Discotic Polymer

According to the combinations shown in Table 2-11, discotic polymer was mixed, in dichloromethane, with 0.5 molar equivalence on the mesogen basis of a complex-forming compound represented by the formula (4) shown in Table 2-11, or with a comparative compound (XA-1) shown below, the mixture was concentrated, heated at 120° C. for 30 minutes, air-cooled, and allowed to stand for 24 hours. On the disk, 3.0 mg of each sample was placed, dissolved with dichloromethane so as to uniformly spread it over the disk, to thereby obtain a film of approximately 6 μm thick. Load is applied to the cylinder, and the coefficient of friction over 40° C. to 110° C. was measured under reciprocative sliding according to conditions similar to those for Example 2-51. Coefficients of friction at 40° C. and presence/absence of sliding mark are shown in Table 2-11.

Next, viscosity index was evaluated under conditions similar to those for Example 2-2. Results are shown in Table 2-11.

TABLE 22

| | Complex- | Coefficient | | |
|---|---|---|---|---|
| Discotic | forming | of friction | Viscosity | Sliding |
| polymer | compound | at 40° C. | index | mark |
| DSP-36 | CP-1 | 0.08 | 154 | ◯ |
| DSP-36 | — | 0.18 | 153 | ◯ |
| DSP-36 | XA-1 | 0.14 | 153 | X |

[Formula 38]

| | |
|---|---|
| C₁₂H₂₅O(C₂H₄O)₄CH₂CO₂CH₃ | XA-1 |

From the results shown in Table 2-11, it is understandable that the coefficient of friction of DSP-35 at 40° C. is large in a film form, due to its relatively high viscosity, but decreases distinctively when added with the complex-forming compounds. This is supposedly because the polymer lowers its viscosity by forming the complex, and develops distinct effect of reducing friction. On the other hand, the composition using XA-1 having no complex-forming ability despite its closely resembled structure reduced the coefficient of friction to a certain degree by virtue of its dilution effect, but also lowered strength of film due to its solvent effect, to thereby degrade the anti-wearing property. In addition, viscosity index was improved supposedly because the complex formation further enhanced the viscosity increasing effect. As described in the above, the complex formation was found to effectively function on the lubricating performance.

The lubricant composition of the present invention can exhibit performances equivalent to those of the currently-available viscosity index improvers, more desirable shearing stability, and an effect of reducing friction equivalent or better than those of the products added with molybdenum-base FM agent. Because interaction with the boundary is not essential requirement for the lubricant composition of the present invention, the lubricant composition is applicable to lubrication of any kinds of boundaries, without being limited by materials but only by surface roughness. As a general consequence, the lubricating oil of the present invention may be excellent in fuel saving property.

It is therefore understandable from the above-described Examples that the lubricant composition of the present invention, when used as an engine oil, can reduce the amount of coking to an equivalent or still lower level achieved by the conventional engine oils added with OCP-base viscosity index improvers, can be lowered in the TBS viscosity, raised in the viscosity index, and improved in the shearing stability as compared with the case where the OCP-base viscosity index improvers are used, and that they can develop low coefficient of friction and desirable anti-wearing property comparative to those achieved by organic molybdenum compounds, which may give lowest coefficient of friction among the conventional technologies, over wide ranges of output and temperature.

### INDUSTRIAL APPLICABILITY

The present invention can provide an excellent engine oil capable of satisfying requirements on automotive fuel saving for the future, and a lubricant composition applicable to various applications such as bearing oil, and is excellent in environmental friendliness.

1. A lubricant composition comprising a polymer having a mesogen structure in a main chain and/or side chains thereof.

2. The lubricant composition of claim 1, wherein said mesogen structure is a discotic structure.

3. The lubricant composition of claim 1, wherein said polymer has an oligoalkyleneoxy chain, oligosiloxy chain or oligoperfluoroalkyleneoxy chain in the main chain and/or side chains thereof.

4. The lubricant composition of claim 1, wherein said polymer has said mesogen structure in the main chain thereof.

5. The lubricant composition of claim 4, wherein said polymer comprises a repeating unit represented by the formula (1-1) below: 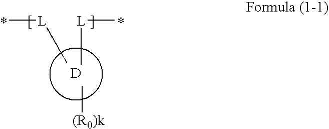
in the formula (1-1), D represents a cyclic mesogen group, each R⁰ independently represents a substituent substitutable on said cyclic mesogen group D, wherein k being not larger than a possible largest number of substitution, each L independently represents a divalent linking group, where at least one of R⁰s and Ls has an oligoalkyleneoxy chain, oligosiloxy chain or oligoperfluoroalkyleneoxy chain therein, and k is an integer of 0 or larger.

6. The lubricant composition of claim 4, wherein said polymer comprises a repeating unit represented by the formula (1-2)-a or (1-2)-b below: 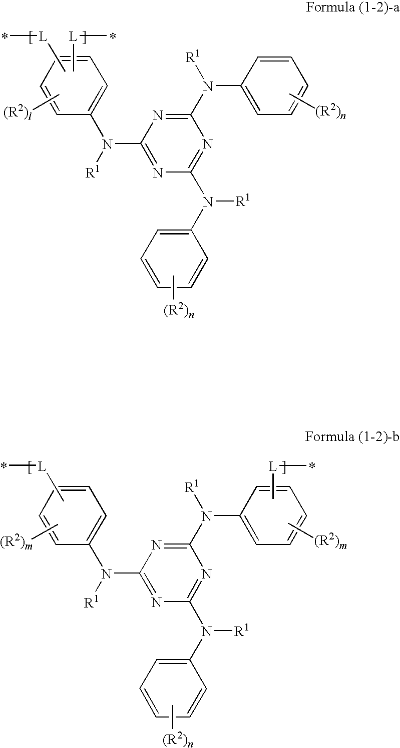
in the formulae (1-2)-a and (1-2)-b, each R¹ independently represents a hydrogen atom or alkyl group, each R² independently represents a substituent, l represents an integer of 0 to 3, m represents an integer of 0 to 4, and n represents an integer of 0 to 5, a plurality of ms and ns in the formulae may be same or different, a plurality of R²s may be same or different when l, m and n are 2 or larger, each L independently represents a divalent linking group, where at least one of R²s and Ls has an oligoalkyleneoxy chain, oligosiloxy chain or oligoperfluoroalkyleneoxy chain therein.

7. The lubricant composition of claim 4, wherein said polymer is represented by the formula (1-3)-a or (1-3)-b below: 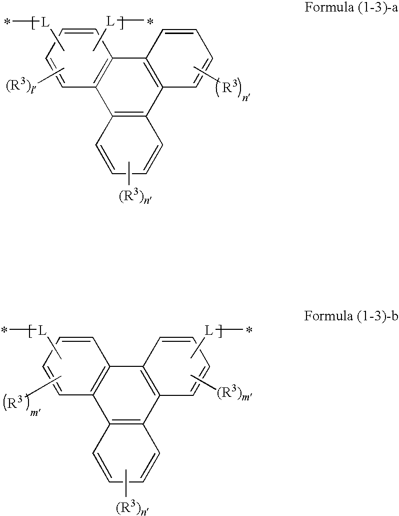
in the formulae (1-3)-a and (1-3)-b, each R³ independently represents a substituent, l′ represents an integer of 0 to 2, m′ represents an integer of 0 to 3 and n′ represents an integer of 0 to 4, a plurality of m's and n's in the formulae may be same or different, a plurality of R³s may be same or different if l′, m′ and n′ are 2 or larger, each L independently represents a divalent linking group, where at least one of R³s and Ls has an oligoalkyleneoxy chain, oligosiloxy chain or oligoperfluoroalkyleneoxy chain therein.

8. The lubricant composition of claim 4, wherein said polymer is polyester comprising a repeating unit derived from condensation of ester bonds.

9. The lubricant composition of claim 1, wherein said polymer has said mesogen structure in the side chains thereof.

10. The lubricant composition of claim 9, wherein said polymer has at least a repeating unit represented by the formula (2-1) below: 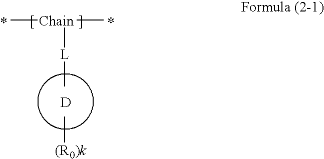
in the formula (2-1), “Chain” is a repeating unit derived from monomers composing the main chain, having at least L as a substituent, D represents a cyclic mesogen group, each R⁰ independently represents a substituent substitutable on said cyclic mesogen group D, wherein k being not larger than a possible largest number of substitution, each L independently represents a divalent linking group, where at least one of R⁰s and L has an oligoalkyleneoxy chain, oligosiloxy chain or oligoperfluoroalkyleneoxy chain therein, and k is an integer of 0 or larger.

11. The lubricant composition of claim 9, wherein said polymer comprises at least a repeating unit represented by the formula (2-2) below: 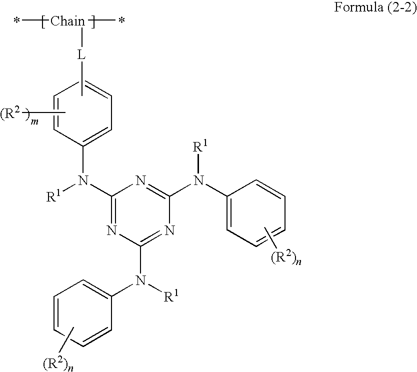
in the formula (2-2), “Chain” is a repeating unit derived from monomers composing the main chain, having at least L as a substituent, each R¹ independently represents a hydrogen atom or alkyl group, each R² independently represents a substituent, m represents an integer of 0 to 4 and n represents an integer of 0 to 5, a plurality of ns in the formula may be same or different, a plurality of R²s may be same or different if m and n are 2 or larger, each L independently represents a divalent linking group, where at least one of R²s and L has an oligoalkyleneoxy chain, oligosiloxy chain or oligoperfluoroalkyleneoxy chain.

12. The lubricant composition of claim 9, wherein said polymer has at least a repeating unit represented by the formula (2-3) below: 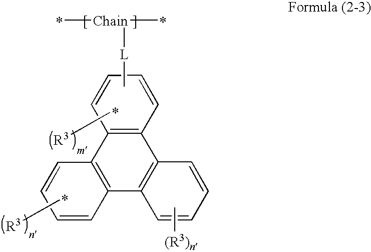
in the formula (2-3), “Chain” is a repeating unit derived from monomers composing the main chain, having at least L as a substituent, each R³ independently represents a substituent, m′ represents an integer of 0 to 3 and n′ represents an integer of 0 to 4, a plurality of n's appear in the formula may be same or different, a plurality of R³s may be same or different if m′ and n′ are 2 or larger, L represents a divalent linking group, where at least one of R³s and L has an oligoalkyleneoxy chain, oligosiloxy chain or oligoperfluoroalkyleneoxy chain therein.

13. The lubricant composition of claim 9, wherein the polymer is a (meth)acrylate-base polymer, polyethylene oxide-base polymer or polysiloxane-base polymer.

14. The lubricant composition of claim 1, wherein said polymer has a weight-average molecular weight of 5,000 to 200,000.

15. The lubricant composition of claim 1, wherein the mount of said polymer is 0.1 to 30% by mass relative to the total mass.

16. The lubricant composition of claim 1, further comprising 70 to 99.9% by mass of a lubricating oil relative to the total mass.

17. The lubricant composition of claim 1, said polymer is in a form of dispersed particles having a mean particle size of 10 nm to 10 μm.

18. The lubricant composition of claim 1, further comprising at least one species of polymer different from said polymer.

19. The lubricant composition of claim 1, further comprising at least one species of compound represented by the formula (4)-a, b, c, d, e, f or g below: 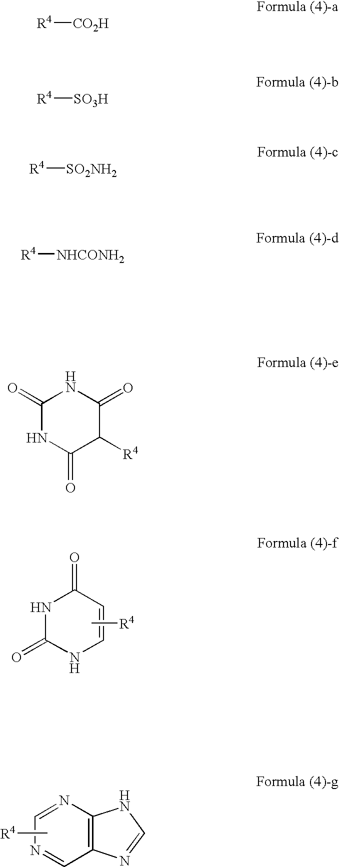
in the formulae, R⁴ represents a substituted alkyl group, phenyl group or heterocyclic group, each of which being substituted by at least one substituent containing a divalent C₈ or longer alkylene group, oligoalkyleneoxy chain, oligosiloxy chain, oligoperfluoroalkyleneoxy chain or disulfide group.

20. A viscosity index improver comprising the lubricant composition of claim 1.

21. A friction modifier comprising the lubricant composition of claim 1.
